(19) United States
(12) Patent Application Publication
(10) Pub. No.: US 2023/0160037 A1
(43) Pub. Date: May 25, 2023

(54) METALS RECOVERY FROM SPENT CATALYST

(71) Applicant: Chevron U.S.A. Inc., San Ramon, CA (US)

(72) Inventors: Rahul Shankar Bhaduri, Moraga, CA (US); Bruce Edward Reynolds, Martinez, CA (US); Oleg A. Mironov, Hercules, CA (US); Alexander Kuperman, Orinda, CA (US); Woodrow K. Shiflett, Richmond, CA (US)

(21) Appl. No.: 17/794,157

(22) PCT Filed: Jan. 20, 2021
(86) PCT No.: PCT/US2021/014098

§ 371 Date: Jul. 20, 2022

Related U.S. Application Data
(60) Provisional application No. 62/963,222, filed on Jan. 20, 2020.
(60) Provisional application No. 62/963,215, filed on Jan. 20, 2020.

(51) Int. Cl. C22B 34/34; C22B 34/22; C22B 7/00; C22B 1/02

(52) U.S. Cl. CPC C22B 34/345; C22B 1/02; C22B 7/006; C22B 34/225

(57) ABSTRACT

An improved method for recovering metals from spent catalysts, particularly from spent slurry catalysts, is disclosed. The method and associated processes comprising the method are useful to recover spent catalyst metals used in the petroleum and chemical processing industries. The method generally involves a combination of a pyrometallurgical and a hydrometallurgical method and includes forming a potassium carbonate calcine of a KOH leach residue of the spent catalyst containing an insoluble Group VIIIB/Group VIB/Group VB metal compound combined with potassium carbonate, and extracting and recovering soluble Group VIB metal and soluble Group VB metal compounds from the potassium carbonate calcine.

### CROSS-REFERENCE TO RELATED APPLICATIONS

This application is the national stage application of International Appl. No. PCT/US2021/14098 (doc. No. T-11120B), and claims the benefit of priority to U.S. Provisional Pat. Appl. Ser. No. 62/963,215, filed on Jan. 20, 2020, entitled “Metals Recovery from Spent Catalyst” (doc. no. T-11120-P3) and U.S. Provisional Pat. Appl. Ser. No. 62/963,222, filed on Jan. 20, 2020, entitled “Metals Recovery from Spent Catalyst” (doc. no. T-11120-P2), the disclosures of which are herein incorporated by reference in their entirety.

### FIELD OF THE INVENTION

The invention concerns a method for recovering metals from spent catalysts, including spent slurry hydroprocessing catalysts.

### BACKGROUND OF THE INVENTION

Catalysts have been widely used in the refining and chemical processing industries for many years. Hydroprocessing catalysts, including hydrotreating and hydrocracking catalysts, are now widely employed in facilities world-wide. Used or “spent” hydroprocessing catalysts that are no longer sufficiently active (or that require replacement for other reasons) typically contain metal components such as molybdenum, nickel, cobalt, vanadium, and the like.

With the advent of heavier crude feedstock, refiners are forced to use more catalysts than before for hydroprocessing to remove sulfur and contaminants from the feedstock. These catalytic processes generate significant quantities of spent catalyst serving a two-fold purpose viz. having lucrative metal values and foregoing landfill in accordance with environmental awareness thereof.

Various processes for recovering catalyst metals from spent catalysts are described in the literature. U.S. Pat. Publication No. 2007/0025899, for example, discloses a process to recover metals such as molybdenum, nickel, and vanadium from a spent catalyst with a plurality of steps and equipment to recover the molybdenum and nickel metal complexes. U.S. Pat. No. 6,180,072 discloses another complex process requiring oxidation steps and solvent extraction to recover metals from spent catalysts containing at least a metal sulphide. U.S. Pat. No. 7,846,404 discloses a process using pH adjustment and precipitation, for recovery of metals from ammoniacal pressure leach solution generated through oxidative pressure leaching of spent catalyst. U.S. Pat. Publication No. 2007/0,025,899 further discloses a process to recover metals such as molybdenum, nickel, and vanadium from a spent catalyst with a plurality of steps and equipment to recover the molybdenum and nickel metal complexes. U.S. Pat. No. 6,180,072 discloses another complex process requiring solvent extraction as well as oxidation steps to recover metals from spent catalysts containing at least a metal sulphide.

Despite the progress made in recovering catalyst metals from spent catalysts, particularly in hydrometallurgical methods, a continuing need exists for an improved and simplified process to recover catalyst metals from spent catalysts, including but not limited to molybdenum, nickel, and vanadium.

### SUMMARY OF THE INVENTION

The present invention is directed to a method for recovering catalyst metals from spent catalysts, particularly spent hydroprocessing catalysts such as slurry catalysts. One of the goals of the invention is to provide improvements in spent catalyst metals recovery processes that provide lower capital and operating costs for metals recovery, preferably at increased metals recovery efficiency. The invention provides an innovative and cost-effective approach for catalyst metals recovery, while also providing improvements in overall catalyst metals recovery, that addresses important environmental sustainability needs in the oil and gas and metals recovery industries.

An improved method for recovering metals from spent catalysts, particularly from spent slurry catalysts, is disclosed. The method and associated processes comprising the method are useful to recover catalyst metals used in the petroleum and chemical processing industries. The method generally involves both pyrometallurgical and hydrometallurgical techniques and methods. The pyrometallurgical method includes an oxidizing roast of the spent catalyst into calcine. The calcine is then (hydrometallurgically) leached with caustic potash or KOH solution to yield soluble Group VB and VIB metals and a residue comprising of Groups VB, VIB and VIIIB metals. The residue is calcined with potassium carbonate and then (hydrometallurgically) leached in hot water to yield soluble Group VB and VIB metals and an insoluble Group VIIIB residue. The soluble Group VB and VIB metal streams are combined & the Group VB and VIB metals separated via conversion of the metals into their ammonium form, crystallization of the Group VB metal followed by acidification of the barren Group VB stream to precipitate out the Group VIB metal.

In one aspect, the pyrometallurgical method comprises heating a deoiled spent catalyst comprising a Group VIB metal, a Group VIIIB metal, and a Group VB metal under oxidative conditions at a first pre-selected temperature for a first time sufficient to reduce the levels of sulfur and carbon present in the catalyst to less than pre-selected amounts and to form a calcined spent catalyst; contacting the calcined spent catalyst with a caustic potash or KOH leach solution to form a spent catalyst slurry at a pre-selected leach temperature for a pre-selected leach time and at a pre-selected leach pH; separating and removing a filtrate and a solid residue from the spent catalyst slurry, the filtrate comprising a soluble Group VIB metal compound and a soluble Group VB metal compound and the solid residue comprising an insoluble Group VIII/Group VIB/Group VB metal compound; drying the insoluble Group VIII/Group VIB/Group VB metal compound solid residue; combining the dried Group VIII/Group VIB/Group VB metal compound solid residue with anhydrous potassium carbonate to form a solid residue/ potassium carbonate mixture; heating the metal compound solid residue/potassium carbonate mixture at a second pre-selected temperature and for a second pre-selected time under air to form a potassium carbonate calcine; contacting the potassium carbonate calcine with water to form a potassium carbonate calcine slurry at a temperature and for a time sufficient to leach a soluble Group VIB metal compound and a soluble Group VB metal compound from the potassium carbonate calcine; separating and removing a filtrate and a solid residue from the potassium carbonate calcine slurry, the filtrate comprising the soluble Group VIB metal compound and the soluble Group VB metal compound and the solid residue comprising an insoluble Group VIIIB metal compound; and recovering the soluble Group VIB metal compound and the soluble Group VB metal compound from the calcined spent catalyst slurry leach filtrate and from the potassium carbonate calcine slurry leach filtrate.

In another aspect, the method generally relates to the use of potassium carbonate to increase the recovery of metals from spent catalysts, in which a potassium carbonate calcine is formed by combining potassium carbonate with the solid residue from a caustic KOH leach extraction of soluble Group VIB metal and soluble Group VB metal compounds from the spent catalyst calcine, with the soluble Group VIB metal and soluble Group VB metal compounds then extracted and recovered from the potassium carbonate calcine.

In a further aspect, the hydrometallurgical method comprises separately recovering Group VIB and Group VB metal compounds from a solution comprising the Group VIB and Group VB metal compounds by contacting the Group VIB/Group VB metal compound mixture with an ammonium salt under metathesis reaction conditions effective to convert the metal compounds to ammonium Group VB metal and ammonium Group VIB metal compounds; subjecting the solution comprising the ammonium Group VB metal compound to conditions effective for crystallizing the ammonium Group VB metal compound; filtering and washing the crystallized ammonium Group VB metal compound with a saturated ammonium Group VB metal compound wash solution at a pre-selected wash temperature and separately recovering the ammonium Group VB metal compound and an ammonium Group VIB metal compound filtrate; heating the ammonium Group VB metal compound under conditions effective to release ammonia and separately recovering the Group VB metal compound and ammonia; contacting the ammonium Group VIB metal compound filtrate with an inorganic acid under conditions effective to form a Group VIB metal oxide compound precipitate and an ammonium salt of the inorganic acid; filtering and washing the Group VIB metal oxide compound precipitate with an ammonium Group VIB metal oxide compound wash solution at a pre-selected wash temperature and recovering the Group VIB metal oxide compound precipitate.

### BRIEF DESCRIPTION OF THE DRAWINGS

The scope of the invention is not limited by any representative figures accompanying this disclosure and is to be understood to be defined by the claims of the application.

FIG. 1, FIG. 1a, and FIG. 1b are general block diagram schematic illustrations of embodiments of pyrometallurgical methods to recover metals from deoiled spent catalyst according to the invention.

FIG. 2 is a general block diagram schematic illustration of an embodiment of a hydrometallurgical method to recover metals from deoiled spent catalyst according to the invention.

FIG. 3, FIG. 3a, and FIG. 3b are general block diagram schematic illustrations of embodiments of combined pyrometallurgical/hydrometallurgical methods to recover metals from deoiled spent catalyst according to the invention.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“Slurry catalyst” may be used interchangeably with “bulk catalyst” or “unsupported catalyst” or “self-supported catalyst,” meaning that the catalyst composition is not of the conventional catalyst form with a preformed, shaped catalyst support which is then loaded with metals via impregnation or deposition catalyst. Such bulk catalyst may be formed through precipitation, or may have a binder incorporated into the catalyst composition. Slurry or bulk catalyst may also be formed from metal compounds and without any binder. In slurry form, such catalyst comprises dispersed particles in a liquid mixture such as hydrocarbon oil, i.e., a “slurry catalyst”.

“Heavy oil” feed or feedstock refers to heavy and ultra-heavy crudes, including but not limited to resids, coals, bitumen, tar sands, oils obtained from the thermo-decomposition of waste products, polymers, biomasses, oils deriving from coke and oil shales, etc. Heavy oil feedstock may be liquid, semi-solid, and/or solid. Examples of heavy oil feedstock include but are not limited to Canada Tar sands, vacuum resid from Brazilian Santos and Campos basins, Egyptian Gulf of Suez, Chad, Venezuelan Zulia, Malaysia, and Indonesia Sumatra. Other examples of heavy oil feedstock include residuum left over from refinery processes, including “bottom of the barrel” and “residuum” (or “resid”), atmospheric tower bottoms, which have a boiling point of at least 650° F. (343° C.), or vacuum tower bottoms, which have a boiling point of at least 975° F. (524° C.), or “resid pitch” and “vacuum residue” which have a boiling point of 975° F. (524° C.) or greater.

“Treatment,” “treated,” “upgrade,” “upgrading” and “upgraded,” when used in conjunction with a heavy oil feedstock, describes a heavy oil feedstock that is being or has been subjected to hydroprocessing, or a resulting material or crude product, having a reduction in the molecular weight of the heavy oil feedstock, a reduction in the boiling point range of the heavy oil feedstock, a reduction in the concentration of asphaltenes, a reduction in the concentration of hydrocarbon free radicals, and/or a reduction in the quantity of impurities, such as sulfur, nitrogen, oxygen, halides, and metals.

The upgrade or treatment of heavy oil feeds is generally referred herein as “hydroprocessing” (hydrocracking, or hydroconversion). Hydroprocessing is meant as any process that is carried out in the presence of hydrogen, including, but not limited to, hydroconversion, hydrocracking, hydrogenation, hydrotreating, hydrodesulfurization, hydrodenitrogenation, hydrodemetallation, hydrodearomatization, hydroisomerization, hydrodewaxing and hydrocracking including selective hydrocracking.

The term “Hydrogen” or “hydrogen” refers to hydrogen itself, and/or a compound or compounds that provide a source of hydrogen.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

“Spent catalyst” refers to a catalyst that has been used in a hydroprocessing operation and whose activity has thereby been diminished. In general, a catalyst may be termed “spent” if a reaction rate constant of the catalyst is below a certain specified value relative to a fresh catalyst at a specified temperature. In some circumstances, a catalyst may be “spent” is the reaction rate constant, relative to fresh unused catalyst, is 80% or less, or perhaps 50% or less in another embodiment. In one embodiment, the metal components of the spent catalyst comprise at least one of Group VB, VIB, and VIIIB metals (of the Periodic Table), e.g., vanadium (V), molybdenum (Mo), tungsten (W), nickel (Ni), and cobalt (Co). The most commonly encountered metal to be recovered is Mo. While not necessarily limited thereto, the spent catalyst typically contains sulfides of Mo, Ni, and V.

“Deoiled spent catalyst” generally refers to a “spent catalyst”, as described hereinabove, that has been subjected to a deoiling process. In general, deoiled spent catalyst contains some residual oil hydrocarbons, such as unconverted oil and/or hydroprocessing products, as well as other chemical compounds and materials. For example, deoiled spent catalyst may typically contain 15 wt.% or more residual hydrocarbons, or, if processed to remove such hydrocarbons, a reduced amount, such as 1 wt.% or less, or 1000 ppm or less. Content specifications for such additional components are specified herein, as appropriate, whether in general or specific terms.

“Metal” refers to metals in their elemental, compound, or ionic form. “Metal precursor” refers to the metal compound feed in a method or to a process. The term “metal”, “metal precursor”, or “metal compound” in the singular form is not limited to a single metal, metal precursor, or metal compound, e.g., a Group VIB, Group VIII, or Group V metal, but also includes the plural references for mixtures of metals. The terms “soluble” and “insoluble” in reference to a Group VIB, Group VIII, or Group V metal or metal compound means the metal component is in a protic liquid form unless otherwise stated, or that the metal or metal compound is soluble or insoluble in a specified step or solvent.

“Group IIB” or “Group IIB metal” refers to zinc (Zn), cadmium (Cd), mercury (Hg), and combinations thereof in any of elemental, compound, or ionic form.

“Group IVA” or “Group IVA metal” refers to germanium (Ge), tin (Sn) or lead (Pb), and combinations thereof in any of elemental, compound, or ionic form.

“Group V metal” refers to vanadium (V), niobium (Nb), tantalum (Ta), and combinations thereof in their elemental, compound, or ionic form.

“Group VIB” or “Group VIB metal” refers to chromium (Cr), molybdenum (Mo), tungsten (W), and combinations thereof in any of elemental, compound, or ionic form.

“Group VIIIB” or “Group VIIIB metal” refers to iron (Fe), cobalt (Co), nickel (Ni), ruthenium (Ru), rhenium (Rh), rhodium (Rh), palladium (Pd), osmium (Os), iridium (Ir), platinum (Pt), and combinations thereof in any of elemental, compound, or ionic form.

The reference to Mo or “molybdenum” is by way of exemplification only as a Group VIB metal, and is not meant to exclude other Group VIB metals/compounds and mixtures of Group VIB metals/compounds. Similarly, the reference to “nickel” is by way of exemplification only and is not meant to exclude other Group VIIIB non-noble metal components; Group VIIIB metals; Group VIB metals; Group IVB metals; Group IIB metals and mixtures thereof that can be used in hydroprocessing catalysts. Similarly, the reference to “vanadium” is by way of exemplification only for any Group VB metal component that may be present in spent catalysts, and is not intended to exclude other Group VB metals/compounds and mixtures that may be present in the spent catalyst used for metal recovery.

The description of a combination of metal compounds represented by the use of the term “Group VIII/Group VIB/Group VB” to describe metal compounds that may be present is intended to mean that Group VIII, Group VIB or Group VB metal compounds may be present, as well as any combination thereof. For example, if the spent catalyst comprises metal compounds of Mo, V, Ni, and Fe, as oxygen and/or sulfur-containing compounds, the term “Group VIII/Group VIB/Group VB” should be understood to include single and mixed metal compounds, i.e., metal compounds comprising Group VIII, Group VIB, Group VB metals, or a combination thereof. Representative compounds include, e.g., MoS₂, V₂S₃, NiS, FeS, MoO₃, V₂O₃, NiO, V₂O₅, Fe₂O₃, NiMoO₄, FeVO₄, and the like. Similarly, the term “Group VB/Group VIB” metal(s) and metal oxide(s) refers to metal or metal oxide compounds comprising Group VB, Group VIB metals, or a combination thereof.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

The present invention is a method for recovering metals from a deoiled spent catalyst, wherein the catalyst comprises a Group VIB metal, a Group VIIIB metal, and a Group VB metal. In one aspect (referred to herein as “case 1”), the method includes a pyrometallurgical method comprising:
heating a deoiled spent catalyst comprising a Group VIB metal, a Group VIIIB metal, and a Group VB metal under oxidative conditions at a first pre-selected temperature for a first time sufficient to reduce the levels of sulfur and carbon to less than pre-selected amounts and to form a calcined spent catalyst;
contacting the calcined spent catalyst with a leach solution comprising potassium hydroxide leach solution to form a spent catalyst slurry at a pre-selected leach temperature for a pre-selected leach time and at a pre-selected leach pH;
separating and removing a first filtrate and a first solid residue from the spent catalyst slurry, the first filtrate comprising a soluble Group VIB metal compound and a soluble Group VB metal compound and the first solid residue comprising an insoluble Group VIII/Group VIB/Group VB metal compound;
drying the insoluble Group VIII/Group VIB/Group VB metal compound first solid residue;
combining the dried Group VIII/Group VIB/Group VB metal compound first solid residue with potassium carbonate to form a solid residue/potassium carbonate mixture;
heating the metal compound solid residue/potassium carbonate mixture at a second pre-selected temperature and for a second pre-selected time under air to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a second filtrate and a second solid residue from the potassium carbonate calcine slurry, the second filtrate comprising the soluble Group VIB metal compound and the soluble Group VB metal compound and the second solid residue comprising an insoluble Group VIIIB metal compound; and
recovering the soluble Group VIB metal compound and the soluble Group VB metal compound from the calcined spent catalyst slurry first leach filtrate and from the potassium carbonate calcine slurry second leach filtrate.

In another aspect (referred to herein as “case 2”), the method includes a pyrometallurgical method comprising:
heating a deoiled spent catalyst comprising a Group VIB metal, a Group VIIIB metal, and a Group VB metal under oxidative conditions at a first pre-selected temperature for a first time sufficient to reduce the levels of sulfur and carbon to less than pre-selected amounts and to form a calcined spent catalyst;
combining the calcined spent catalyst comprising Group VIII, Group VIB, and Group VB metal compounds with potassium carbonate to form a calcined spent catalyst/potassium carbonate mixture;
heating the calcined spent catalyst/potassium carbonate mixture at a second pre-selected temperature and for a second pre-selected time under gas flow conditions to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a filtrate and a solid residue from the potassium carbonate calcine slurry, the filtrate comprising the soluble Group VIB metal compound and the soluble Group VB metal compound and the solid residue comprising an insoluble Group VIIIB metal compound; and
recovering the soluble Group VIB metal compound and the soluble Group VB metal compound from the potassium carbonate calcine slurry filtrate.

In a further aspect (referred to herein as “case 3”), the method includes a pyrometallurgical method comprising:
combining the spent catalyst comprising Group VIII, Group VIB, and Group VB metal compounds with potassium carbonate to form a spent catalyst/potassium carbonate mixture;
heating the spent catalyst/potassium carbonate mixture under oxidative conditions at a pre-selected temperature for a time sufficient to reduce the levels of sulfur and carbon to less than pre-selected amounts and to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a filtrate and a solid residue from the potassium carbonate calcine slurry, the filtrate comprising the soluble Group VIB metal compound and the soluble Group VB metal compound and the solid residue comprising an insoluble Group VIIIB metal compound; and
recovering the soluble Group VIB metal compound and the soluble Group VB metal compound from the potassium carbonate calcine slurry filtrate.

Each of the three cases (1, 2, and 3) provides for an improved recovery of spent catalyst metals and a cost-effective simplified approach to the recovery of metals from spent catalyst. The method of case 1 utilizes two leaching extraction stages, the first being a caustic potash leach extraction of the deoiled spent catalyst calcine and the second being a water leach extraction of a potassium carbonate calcine formed from the insoluble residue obtained from the caustic potash leach extraction stage combined with potassium carbonate. The method does not require the use of additional extraction stages (within the method), such as the addition of other solvents, or the use of additional treatment organic and/or inorganic compounds in combination with the potash leach solution or with the use of potassium carbonate. By comparison, the method of case 2 utilizes one leaching extraction stage, a water leach extraction of a potassium carbonate calcine formed from the calcined spent catalyst combined with potassium carbonate. The method of case 3 also utilizes one leaching extraction stage, a water leach extraction of a potassium carbonate calcine formed from the spent catalyst combined with potassium carbonate.

The spent catalyst generally originates from a bulk unsupported Group VIB metal sulfide catalyst optionally containing a metal selected from a Group VB metal such as V, Nb; a Group VIIIB metal such as Ni, Co; a Group VIIIB metal such as Fe; a Group IVB metal such as Ti; a Group IIB metal such as Zn, and combinations thereof. Certain additional metals may be added to a catalyst formulation to improve selected properties, or to modify the catalyst activity and/or selectivity. The spent catalyst may originate from a dispersed (bulk or unsupported) Group VIB metal sulfide catalyst promoted with a Group VIIIB metal for hydrocarbon oil hydroprocessing, or, in another embodiment, the spent catalyst may originate from a Group VIIIB metal sulfide catalyst. The spent catalyst may also originate from a catalyst consisting essentially of a Group VIB metal sulfide, or, in another embodiment, the spent catalyst may originate from a bulk catalyst in the form of dispersed or slurry catalyst. The bulk catalyst may be, e.g., a colloidal or molecular catalyst.

Catalysts suitable for use as the spent catalyst in the method are described in a number of publications, including U.S. Pat. Publication Nos. US20110005976A1, US20100294701A1, US20100234212A1,US20090107891A1, US20090023965A1, US20090200204A1, US20070161505A1, US20060060502A1,and US20050241993A.

The bulk catalyst in one embodiment is used for the upgrade of heavy oil products as described in a number of publications, including U.S. Pat. Nos. 7,901,569, 7,897,036, 7,897,035, 7,708,877, 7,517,446, 7,431,824, 7,431,823, 7,431,822, 7,214,309, 7,390,398, 7,238,273 and 7,578,928; U.S. Publication Nos. US20100294701A1, US20080193345A1, US20060201854A1, and US20060054534A1, the relevant disclosures are included herein by reference.

Prior to metal recovery and after the heavy oil upgrade, the spent catalyst may be treated to remove residual hydrocarbons such as oil, precipitated asphaltenes, other oil residues and the like. The spent catalyst prior to deoiling contains typically carbon fines, metal fines, and (spent) unsupported slurry catalyst in unconverted resid hydrocarbon oil, with a solid content ranging from 5 to 50 wt. %. The deoiling process treatment may include the use of solvent for oil removal, and a subsequent liquid/solid separation step for the recovery of deoiled spent catalyst. The treatment process may further include a thermal treatment step, e.g., drying and/or pyrolysis, for removal of hydrocarbons from the spent catalyst. In other aspects, the deoiling may include the use of a subcritical dense phase gas, and optionally with surfactants and additives, to clean/remove oil from the spent catalyst.

The spent catalyst after deoiling typically contains less than 5 wt. % hydrocarbons as unconverted resid, or, more particularly, less than 2 wt. % hydrocarbons, or less than 1 wt. % hydrocarbons. The amount of metals to be recovered from the de-oiled spent catalyst generally depends on the compositional make-up of the catalyst for use in hydroprocessing, e.g., a sulfided Group VIB metal catalyst, a bimetallic catalyst containing a Group VIB metal and a Group VIIIB metal, or a multi-metallic catalyst with at least a Group VIB and other (e.g., promoter) metal(s). After the oil removal treatment process, the spent catalyst containing metals for recovery may be in the form of a coke-like material, which can be ground accordingly for the subsequent metal recovery process to a particle size typically ranging from 0.01 to about 100 microns.

The deoiling or removal of hydrocarbons from spent catalyst is disclosed in a number of publications, including US7790646, US7737068, WO20060117101, WO2010142397, US20090159505A1, US20100167912A1, US20100167910A1, US20100163499A1, US20100163459A1, US20090163347A1, US20090163348A1, US20090163348A1, US20090159505A1, US20060135631A1, and US20090163348A1.

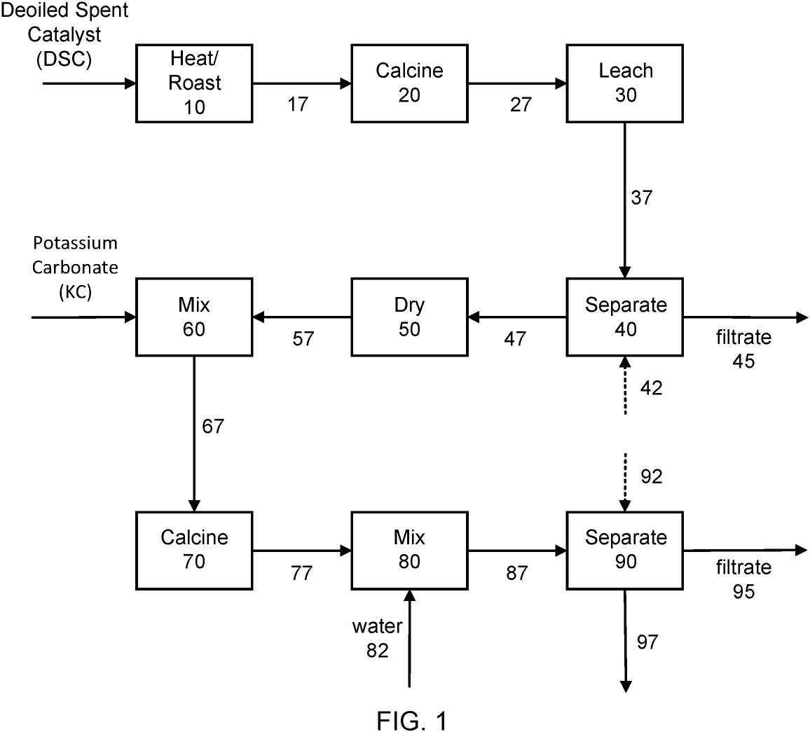

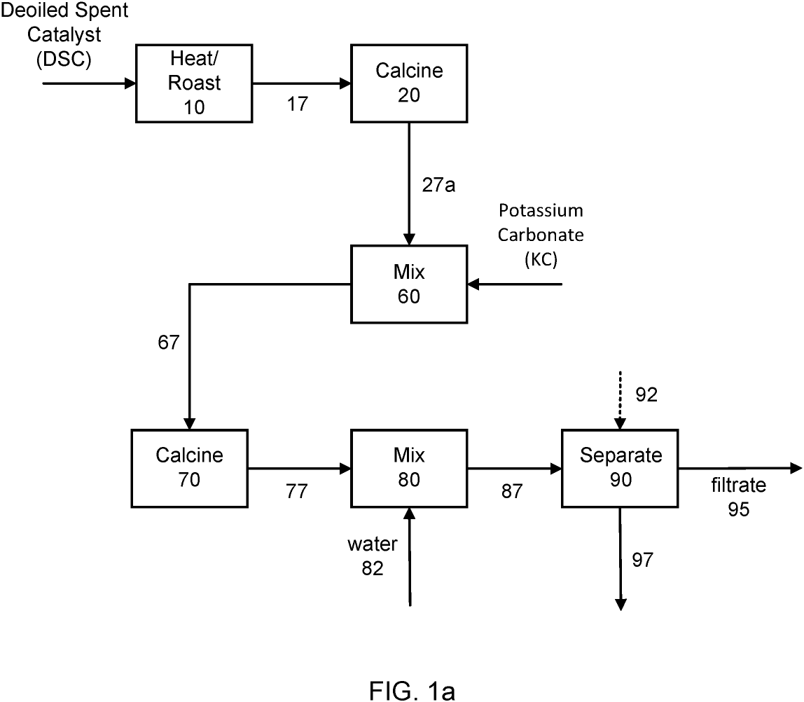

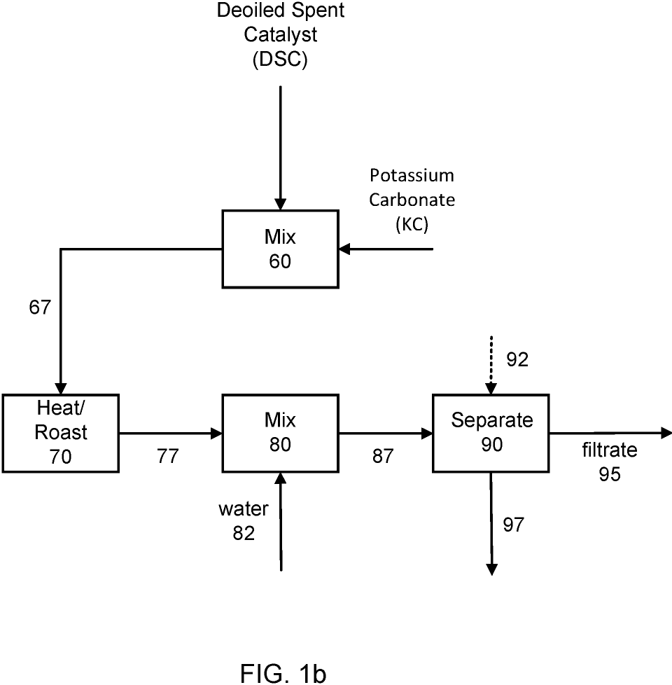

An illustration of a pyrometallurgical method or process according to an embodiment of the invention is shown schematically for case 1 in FIG. 1. Deoiled spent catalyst (DSC), e.g., catalyst that is devoid or substantially devoid of residual hydrocarbons, as described herein, is fed to a heating or roasting stage 10 to reduce the sulfur and/or carbon content present in the catalyst to less than pre-selected amounts and subsequently 17 to form a calcined spent catalyst in calcining stage 20. The heating/roasting and calcining steps may be conducted in the same or different equipment and as individual batch or continuous process steps. Off-gassing of sulfur and carbon from the catalyst may be used to establish the amount of time needed for calcination (or the completion of the calcination step), as previously described. The spent catalyst calcine is subsequently 27 subjected to an extraction (leaching) stage 30 with caustic potash leach comprising KOH (e.g., at a pH of about 10.5), typically at about 15 wt.% solids content, and at about 75° C. for a few (2-3) hours. The leach slurry is subsequently 37 subjected to separation 40 of the filtrate 45 from the solid residue, typically with a wash 42 of, e.g., alkaline hot water. The filtrate comprises soluble Group VIB and Group VB metals and is separated for subsequent recovery of the metals while the insoluble solid residue 47 is dried 50, e.g., at 125° C. until the water content is less than a suitable amount, e.g., about 1 wt.%. The dried solid residue is subsequently 57 mixed 60 with potassium carbonate (e.g., anhydrous particulate potassium carbonate having a particle size that is predominantly less than 100 µm) and the dried mixture is subsequently 67 calcined 70. Typical calcination conditions to form the potassium carbonate calcine include temperatures in the range of 600-650° C. The potassium carbonate calcine is subsequently 77 mixed with water 80 to form a potassium carbonate calcine slurry, typically at a temperature of 60-90° C. in order to extract soluble Group VIB and Group VB metal compounds. The slurry is subsequently 87 separated 90 into a filtrate 95 comprising the soluble Group VIB and Group VB metal compounds and a residue 97 comprising insoluble compounds (such as, e.g., Ni, Fe and other metal compounds). Filtrates 45 and 95 may be subjected to further processing to recover the Group VB and Group VIB metal compounds, e.g., in the case of vanadium and molybdenum, as V₂O₅ and MoO₃. Residue 97 may also be further processed for possible metals recovery or sent to a smelter.

An illustration of a pyrometallurgical method or process according to an embodiment of the invention is shown schematically for case 2 in FIG. 1a. The method of case 2 includes the same steps as the method of case 1, with the exception that the leaching/extraction, separation, and drying steps, e.g., as shown in FIG. 1 as steps 30, 40, and 50, are not included in the case 2 method as shown in FIG. 1a. The foregoing description for the numbered steps shown in FIG. 1 are the same as shown in FIG. 1a and as described hereinabove.

The pyrometallurgical method or process according to the case 3 embodiment of the invention is shown schematically in FIG. 1b. The method of case 3 includes the same steps as the method of case 2, with the exception that certain steps, e.g., steps 10 and 20 as shown in FIG. 1a, are not included in the case 3 method as shown in FIG. 1b. The foregoing description for the numbered steps shown in FIG. 1 and FIG. 1a and as described hereinabove are otherwise the same as for the case 3 method shown in FIG. 1b. The case 3 method utilizes heating/roasting of the spent catalyst and potassium carbonate mixture as shown by 70 of FIG. 1b. In this case, the deoiled spent catalyst is directly mixed with potassium carbonate and heated/roasted at a lower temperature (e.g., in the range of 575-600° C. for up to about 8 hr). The calcine 70 is subsequently 77 mixed with water 80 to form a potassium carbonate calcine slurry, typically at a temperature of 60-90° C. in order to extract soluble Group VIB and Group VB metal compounds. The slurry is subsequently 87 separated 90 into a filtrate 95 comprising the soluble Group VIB and Group VB metal compounds and a residue 97 comprising insoluble compounds (such as, e.g., Ni, Fe and other metal compounds). Filtrate 95 may be subjected to further processing to recover the Group VB and Group VIB metal compounds, e.g., in the case of vanadium and molybdenum, as V₂O₅ and MoO₃. Residue 97 may also be further processed for possible metals recovery or sent to a smelter.

The initial heating/roasting stage (10 in FIG. 1 and FIG. 1a) is generally used, when needed or as appropriate, to remove residual hydrocarbons before subsequent calcining of the spent catalyst. For deoiled spent catalyst having a low content of residual hydrocarbons, e.g., less than about 1000 ppm, such as may be obtained for catalyst that has been pre-processed, the initial heating/roasting stage may not be needed. While not limited thereto, the heating may comprise, e.g., a slow ramp to an initial temperature, e.g., in the range of 350-500° C., under an inert gas such as argon, for a suitable period of time to remove residual hydrocarbons (e.g., 1-2 hr).

Calcining of the spent catalyst is subsequently carried out, typically by increasing the temperature to an appropriate calcining temperature, e.g., in the range of 600-650° C., under oxygen starved conditions initially (e.g., a mixture of an inert gas such as argon and air), for a suitable period of time to form a calcined spent catalyst (e.g., typically greater than 1-2 hr and less than about 24 hr, or more particularly, less than about 12 hr). In general, the calcined spent catalyst may also be monitored by off-gas analysis for removal of CO₂ and SO₂ during the calcination stage to determine a suitable end point to the calcination. For example, an end point may be associated with CO₂ and SO₂ levels of less than about 1 wt.%, or about 0.8 wt.%, or about 0.5 wt.%, or about 0.2 wt.%, or about 0.1 wt.%.

During the spent catalyst calcination step, oxidative heating conditions generally comprise heating in the presence of an inert gas, air, or a combination thereof. Variations in the oxidative conditions may be employed as needed, e.g. an initial gas environment comprising no more than about 20 vol.% oxygen may be followed by gas conditions comprising more than about 80 vol.% oxygen may also be used.

During calcination of the spent catalyst, e.g., when the catalyst comprises, e.g., Mo, Ni, V, Fe, C, and S, the following representative reactions are believed to form the following compounds and off-gas products

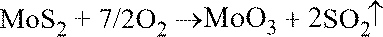

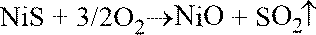

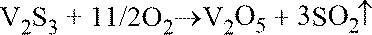

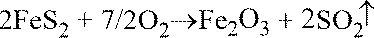

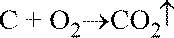

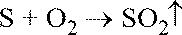

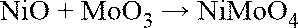

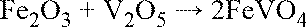

Following the spent catalyst calcination, a leaching extraction step in alkali is conducted to leach soluble metal compounds, forming a first filtrate and an insoluble metal compound(s) residue comprising insoluble Group VIII/Group VIB/Group VB metal compound(s). The filtrate typically comprises soluble molybdate and vanadate compounds while the insoluble compounds typically comprise mixed metal compounds. For example, in the case of the foregoing representative reactions noted, such insoluble metal compounds are believed to comprise NiO, Fe₂O₃, NiMoO₄ and FeVO₄. While not necessarily limited thereto, typical leach conditions comprise a leach temperature in the range of about 60 to 90° C., or 60 to 80° C., or 70 to 80° C., or greater than about 60° C., or 70° C.; a leach time in the range of about 1-5 hr, or about 2-5 hr, or about 2-4 hr.; and a leach pH in the range of about 9.5 to 11, or about 10 to 11, or about 10 to 10.5. In the case of Mo and V metal compounds, the KOH leach reactions are believed to include:

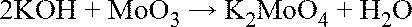

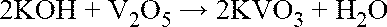

The reaction of certain insoluble Group VB and Group VIB metal compounds (referred to as a “spinel”) with potassium carbonate are, in the case of Mo and V metal compounds for the method of cases 1 and 2, believed to include:

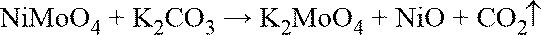

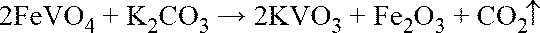

In the case 3 method, because the deoiled spent catalyst is directly mixed with potassium carbonate, the reactions of certain Group VB, Group VIB and Group VIIIB metal compounds with potassium carbonate are believed to include:

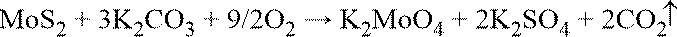

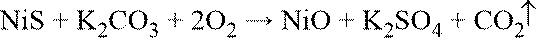

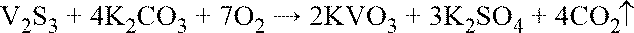

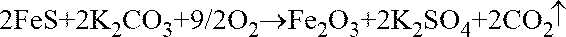

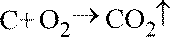

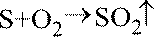

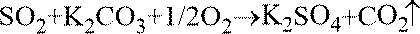

The first filtrate (case 1) and filtrate (case 2 or 3) generally contains greater than about 80 wt.% of the Group VIB metal or greater than about 85 wt.% of the Group VB metal present in the deoiled spent catalyst, or both greater than about 80 wt.% of the Group VIB metal and greater than about 85 wt.% of the Group VB metal present in the deoiled spent catalyst.

The residue from the caustic potash leach stage typically comprises Group VB/Group VIB/Group VIIIB metal oxide solids and is subsequently separated from the filtrate and dried under suitable conditions, e.g., at a temperature in the range of about 110-140° C., or about 110-130° C., or about 120-130° C. for a time period in the range of 0.5 to 2 hr, or 1 to 2 hr. Typically, the first solid residue is dried at a temperature and for a time sufficient to reduce the amount of water to less than about 2 wt.%, or 1 wt.%, or 0.5 wt.%, or 0.2 wt.%, or 0.1 wt.%.

The dried caustic potash leach residue is subsequently mixed with potassium carbonate under suitable conditions to form a well-mixed particulate or powder mixture of the solid residue/potassium carbonate. The solid residue/potassium carbonate mixture is subsequently subjected to a heating/ calcination step to form a potassium carbonate calcine, typically at a second pre-selected temperature in the range of about 600° C. to 650° C., or about 600° C. to 640° C., or about 610° C. to 630° C., or greater than about 600° C., or about 610° C., or about 620° C., or about 630° C., or about 640° C., or about 650° C., and for a second pre-selected time in the range of about 0.5 to 2 hr, or 1 to 2 hr. Sufficient gas flow conditions are typically used comprising of air to flush off-gases.

The potassium carbonate calcine is subsequently contacted with water to form a potassium carbonate calcine slurry, typically at a temperature in the range of about 60 to 90° C., or 60 to 80° C., or 70 to 80° C., or at a temperature greater than about 60° C., or 70° C. While not limited thereto, the potassium carbonate calcine leach time is typically in the range of 0.5 to 4 hr, or 1 to 3 hr, or 2 to 3 hr. The pH may be modified as needed, although typically no pH modification is needed during this step. Representative metal compounds present in the second filtrate comprise potassium molybdate, potassium vanadate, or a mixture thereof.

More broadly, the second filtrate contains the Group VB metal present in the Group VB/Group VIB metal oxide in an amount greater than about 60 wt.%, or about 70 wt.%, or about 80 wt.%, or about 90 wt.%. In addition, the second filtrate contains the Group VIB metal present in the Group VB/Group VIB metal oxide in an amount greater than about 90 wt.%, or about 95 wt.%, or about 97 wt.%, or about 98 wt.%, or about 99 wt.%.

The first filtrate from the caustic potash leach extraction stage and the second filtrate from the potassium carbonate calcine water leach extraction stages may be further processed and/or treated to recover the soluble Group VB and Group VIB metals.

In terms of the overall extraction of spent catalyst metals, the overall extraction of the Group VB metal present in the deoiled spent catalyst is greater than about 85 wt.%, or about 90 wt.%, or about 95 wt.%, or about 97 wt.%, or about 98 wt.%, or about 99 wt.%. Similarly, the overall extraction of the Group VIB metal present in the deoiled spent catalyst is greater than about 90 wt.%, or about 95 wt.%, or about 97 wt.%, or about 98 wt.%, or about 99 wt.%.

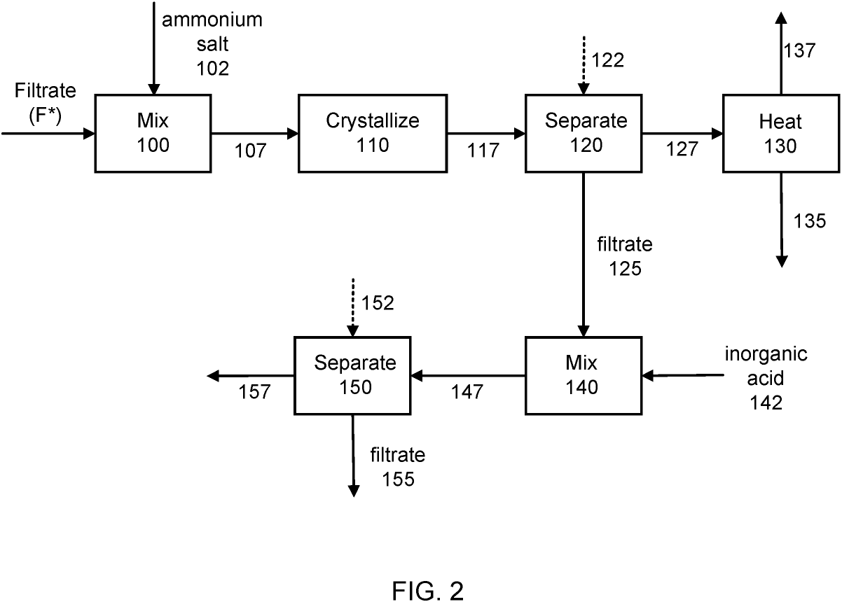

An illustration of a hydrometallurgical method or process according to an embodiment of the invention is shown schematically in FIG. 2. Filtrate (F*) from one or more sources, e.g., spent catalyst filtrate streams 45 and 95 from the pyrometallurgical methods shown in FIG. 1, FIG. 1a, and FIG. 1b comprising a Group VIB metal compound and Group VB metal compound aqueous mixture is mixed 100 with an ammonium salt 102 under metathesis reaction conditions to convert the metal compounds to ammonium Group VB metal and ammonium Group VIB metal compounds. The metathesis reaction mixture is subsequently subjected to crystallization conditions 107, 110 effective to crystallize the ammonium Group VB metal compound. The crystallized ammonium Group VB metal compound is subsequently passed 117 for separation 120 and recovery of the ammonium Group VB metal compound and an ammonium Group VIB metal compound filtrate 125. A saturated ammonium Group VB metal compound wash solution 122 at a pre-selected wash temperature may be used as necessary for filtering and washing of the ammonium Group VB metal compound crystals. The ammonium Group VB metal compound is subsequently passed 127 to for heating 130 and ammonia removal under conditions effective to release ammonia and for separately recovering the Group VB metal compound 135 and ammonia 137. The ammonium Group VIB metal compound filtrate from the separation step 120 is subsequently passed for mixing 140 with an inorganic acid 142 under conditions effective to form mixture of a Group VIB metal oxide compound precipitate and an ammonium salt of the inorganic acid. The mixture of the precipitate and salt are subsequently passed 147 for separation 150 of the Group VIB metal oxide compound precipitate and recovering the Group VIB metal oxide compound precipitate 157. An ammonium Group VIB metal oxide compound wash solution 152 at a pre-selected wash temperature may be used as necessary for filtering and washing of the Group VIB metal oxide compound precipitate. The filtrate 155 from separation 150 may be subsequently subjected to further metals recovery steps as necessary, e.g., through ionic resin exchange steps, optionally with ammonium nitrate/potassium nitrate recovery as a fertilizer source.

Mixing of the filtrate (F*) with the ammonium salt is typically conducted under conditions that are effective to convert the Group VIB and Group VB metal compounds into ammonium Group VB metal and ammonium Group VIB metal compounds. Seed crystals such as ammonium metavanadate (AMV) may be used, typically in a concentration of about 2000-8000 ppm, or 4000-6000 ppm, or about 5000 ppm. Typically, the pH range is less than about 8 when AMV seed is introduced. Although the skilled artisan may readily determine suitable methods to conduct the metathesis reaction, one useful procedure is to first reduce the pH to about 9 using nitric acid, followed by the introduction of ammonium nitrate and the introduction of AMV seed at a pH of less than about 8, preferably 8 or less, or in the range of 7.5 to 8.5, or 7.5 to 8.

During the mixing and metathesis reactions of the filtrate (F*), e.g., when the filtrate is derived from a spent catalyst comprising, e.g., Mo, Ni, V, Fe, C, and S, the following representative reactions are believed to form soluble (Mo) and insoluble (V) metal compounds:

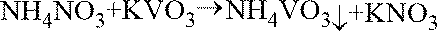

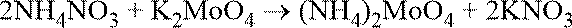

The crystallization conditions, e.g., when ammonium metavanadate (AMV) crystals are to be produced, typically involve reduced temperature and pressure, e.g., a temperature of about 10° C. under a vacuum of about 21 in. Hg may be used. The skilled artisan will appreciate that different temperature and pressure (vacuum) conditions and crystallization times may be used. In general, a temperature in the range of greater than 0° C. to about 15° C., or greater than 0° C. to about 10° C., vacuum conditions, and a crystallization time period of about 1 hr to about 6 hr, or about 1 hr to about 4 hr, or about 1 hr to about 3 hr are useful. Filtration and washing of the crystals with wash solution at lowered temperatures, e.g., an AMV wash solution of about 5000 ppm at about 10° C. may be used. Multiple washes of about 2-5 times, or about 3 times along with recycling of the wash solution to the crystallization step may be used as well. Typically, a wash temperature in the range of greater than 0° C. to about 15° C., or greater than 0° C. to about 10° C., or a wash solution temperature of about 10° C., has been found to be suitable, preferably wherein the crystallized ammonium Group VB metal compound and the wash solution comprise ammonium metavanadate and, optionally, wherein the wash solution is recycled for crystallization of the ammonium Group VB metal compound.

The ammonium Group VB metal compound may be subsequently heated at a temperature in the range of about 200-450° C., or 300-450° C., or 350-425° C., or about 375-425° C. for a time sufficient to release ammonia in an amount of at least about 90%, or 95%, or 98%, or 99% of the amount present in the ammonium Group VB metal compound. The Group VB metal compound may be subsequently further treated, e.g., melted in a fusion furnace and the melt discharged to a flaker wheel to produce Group VB metal compound flake. The overall recovery of the Group VB metal present in the aqueous mixture comprising the Group VIB and Group VB metal compounds may be greater than about 90 wt.%, or about 95 wt.%, or about 97 wt.%, or about 98 wt.%, or about 99 wt.%.

The acidulation conditions for contacting of the ammonium Group VIB metal compound filtrate with an inorganic acid comprise introducing the inorganic acid at a temperature in the range of about 50-80° C., or 50 to 70° C., or 55 to 70° C. to provide a pH of about 1 to 3, or about 1 to 2, or about 1, preferably wherein the inorganic acid comprises nitric acid or sulfuric acid, or is nitric acid.

During the acidulation reactions, e.g., when the filtrate is derived from a spent catalyst comprising, e.g., Mo, Ni, V, Fe, C, and S, the following representative reaction is believed to form an insoluble (Mo) metal compound:

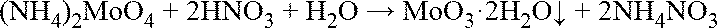

Following the acidulation reaction, separation of the liquid and solid may be conducted using filtration. The conditions for washing of the Group VIB metal oxide compound precipitate may be conducted by re-slurrying the filter cake, at 25-wt% solids with an ammonium Group VIB metal compound wash solution at a wash temperature in the range of greater than 0° C. to about 15° C., or greater than 0° C. to about 10° C., or a wash solution temperature of about 10° C. at pH^{~}1.0 for 15-minutes. Typically, when the spent catalyst comprises Mo as the Group VIB metal, the wash solution comprises ammonium heptamolybdate (AHM) at pH 1.0 that is depleted of molybdenum and simulates the barren filtrate 155 in FIG. 2. Following re-filtration of the slurry, the cake may be re-slurried two more times with fresh pH 1.0 ammonium heptamolybdate solution to lower K content in the MoO₃ cake to <0.5-wt%. As with all wash steps, the wash solution may be optionally recycled for washing, e.g., of the Group VIB metal oxide compound.

The overall recovery of the Group VIB metal present in the aqueous mixture comprising the Group VIB and Group VB metal compounds may be greater than about 90 wt.%, or about 95 wt.%, or about 97 wt.%, or about 98 wt.%, or about 99 wt.%.

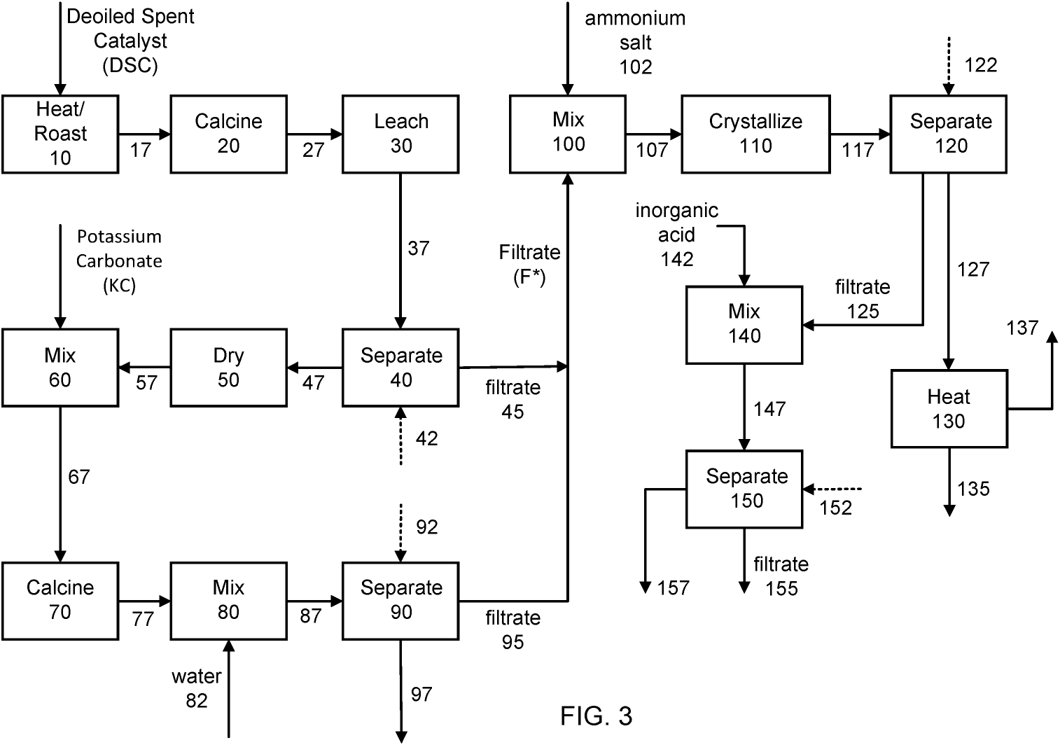

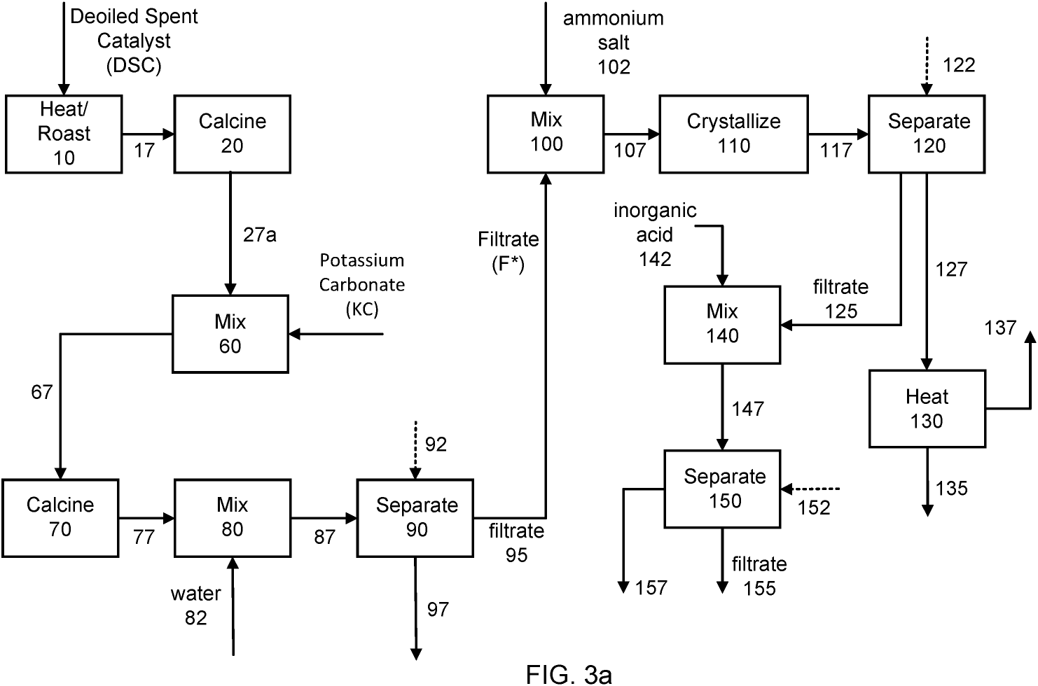

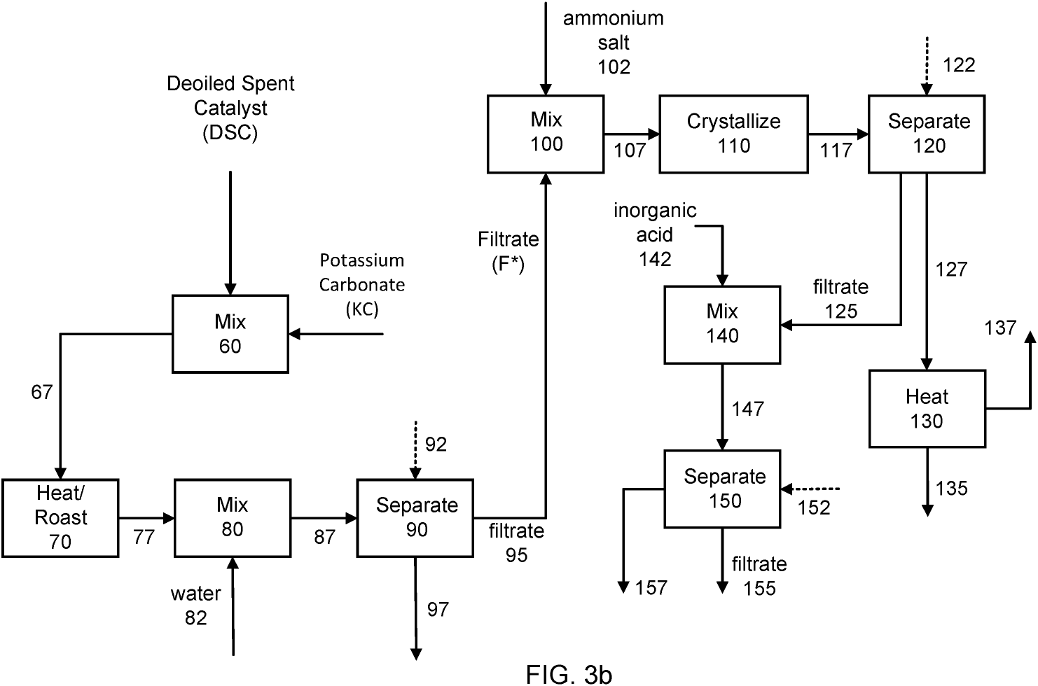

FIG. 3 shows the combined schematic of the case 1 pyrometallurgical method of FIG. 1 with the hydrometallurgical method shown in FIG. 2. FIG. 3a similarly shows the combined use of both methods represented in FIGS. 1a and 2, while FIG. 3b shows the combined use of both methods represented in FIGS. 1b and 2. The foregoing descriptions for each of FIGS. 1, 1a, 1b, and 2 are directly applicable to the combined schematics shown in FIGS. 3, 3a, and 3b.

### EXAMPLES

The following examples provide results for metals recovery from spent slurry catalysts in accordance with the claimed invention. Results for metal recovery using potassium carbonate (potash) in accordance with embodiments of the invention are provided along with comparative results that do not utilize potassium carbonate.

Examples 1A through 1G provide results for as-is roasting of spent catalyst, followed by potassium hydroxide (caustic potash) leaching of the calcine, leach residue calcination with potassium carbonate, hot water leaching of the potassium carbonate calcine, ammonium metavanadate crystallization followed by molybdenum trioxide precipitation.

### Example 1A - Roasting Spent Catalyst (as-is)

Controlled batch oxidation of 1,750-g de-oiled spent catalyst under O₂ starved conditions in a 7” diameter × 29” operating length rotary quartz tube furnace, simulating multiple hearth furnace conditions, with retention times of up-to 8-hrs generated a calcine containing <0.1 wt.% S and C respectively. The run began with a fast ramp-up to 500° C. under Argon gas flow to remove residual hydrocarbons in the spent catalyst. This was followed by a slow ramp to the operating bed temperature of 620° C. under reduced air flow, an extended hold period with CO₂ and SOₓ emission measurements, followed by a slow cool down under air flow during reaction termination; the staged temperature control was a necessity to avoid significant heat release that would result in Mo loss and solids sintering.

A weight loss of approximately 57% (Tables 8 and 9) was observed in a low-V calcine that corresponded to near complete S and C removal (<0.1 wt.%) and conversion of metal sulfides to metal oxides. Tables 1 and 2 illustrate metal assays on roaster spent catalyst feed and generated calcine

TABLE 1

Roaster Feed Average Assays (wt.%)

| Type | Mo | Ni | V | Fe | C | H | S |
|---|---|---|---|---|---|---|---|
| Lo-V | 25.10 | 3.20 | 0.94 | 0.10 | 43.80 | 2.20 | 22.50 |

Table 2

Roaster Calcine Average Assays (wt.%)

| Type | Mo | Ni | V | Fe | C | S |
|---|---|---|---|---|---|---|
| Lo-V | 58.00 | 6.73 | 1.84 | 0.14 | 0.014 | 0.17 |

Reactions (1.1) through (1.6) below represent the pertinent combustion reactions. Gibb’s free energies at 600° C. imply oxidation per the sequence V>Mo>Fe>Ni; free energies at 600° C. for CO₂ and SO₂ imply that C will combust at a faster rate than S.

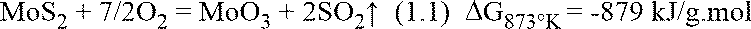

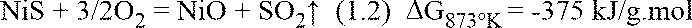

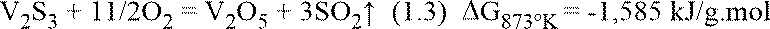

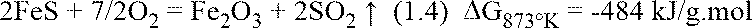

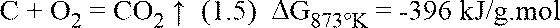

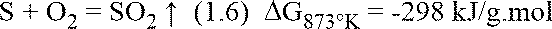

Due to the unsupported, high surface area characteristics of the deoiled material and the absence of alumina and/or silica, reaction 1.7 below depicts Nickel present in the feedstock securing onto Molybdenum during the combustion reactions at approximately 620° C. to form an un-leachable refractory NiMoO₄ ‘spinel’ phase. This component was detected by both XRD & QEMSCAN (Quantitative Evaluation of Materials by Scanning Electron Microscopy).

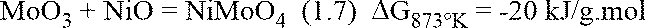

Another phase that could not be detected by XRD but was revealed by QEMSCAN included a mixed metal oxide of the form (MoₐNi_{b}V_{c})O_{d}; the V constituent in the mixed metal oxide was un-leachable in both caustic and acid environments.

### Example 1B - Calcine Leaching With Caustic Potash (KOH)

Caustic potash (KOH, 29 wt.% solution) leaching of the low-V (low vanadium) calcine at 75° C., 15 wt.% solids, pH 10.0 to 10.5 and retention times of 2-hrs yielded up to 83% Mo and 89% V extractions (Table 3). Ni remained in the residue phase as NiMoO₄ (Table 4).

Up to 75% dissolution (Table 9) of the low-V calcine mass in KOH was observed with the remaining mass constituting spinel in the washed leach residue. XRD scans on the leach residue verified the spinel structure as α-NiMoO₄; the refractory V component could not be identified.

TABLE 3

KOH Leach, Kinetic Period Extractions

| Time (min.) | 45 | 90 | 120 | 45 | 90 | 120 |
|---|---|---|---|---|---|---|
| | Mo (%) | | | V(%) | | |
| Lo-Vanadium | 72.4 | 81.1 | 82.5 | 84.4 | 88.2 | 89.0 |

TABLE 4

KOH Leach Residue Average Assays (wt.%)

| Type | Mo | Ni | V | Fe |
|---|---|---|---|---|
| Lo-V | 39.00 | 25.90 | 0.79 | 0.57 |

### Example 1C - Caustic Potash Leach Residue Calcination With K₂CO₃

The low Mo and V extractions obtained from KOH leaching of roasted spent catalyst were a cause for concern in terms of commercial metal recovery and project economics. Further investigations revealed that Nickel molybdate spinel reaction with potassium carbonate at approximately 600° C. would transform the refractory Ni—Mo salt into a soluble Mo version. The conversion may be represented by reaction 1.8:

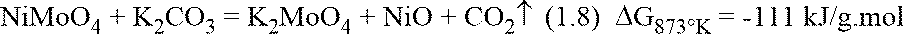

100 g of the dried caustic potash leach residue (spinel) was blended with anhydrous potash (K₂CO₃, Rocky Mountain Reagents, 28% passing 300 µm) at up to 25% above the stoichiometric Mo and V content in the calcine; this was followed by calcination in a 4” diameter × 14” operating length rotary quartz tube furnace under continuous flush with air at between 600° C. and 625° C. for 1.5 hrs.

The run began with a fast ramp-up to 500° C. succeeded by a slow ramp-up to the operating bed temperature of up to 625° C., a hold period of 1.5 hrs, followed by a slow cool down during reaction termination. The sequence was necessary to avoid solids fusibility and sintering issues. Table 5 portrays metal assays in the calcine.

A weight gain of approximately 50% (Table 9) was observed in a low-V calcine that appeared to explain for near complete breaching of the spinel into water soluble molybdate and vanadate. Table 5 depicts elemental composition of the solids following calcination of the caustic potash leach residue with K₂CO₃.

TABLE 5

K₂CO₃ Calcined Spinel Avg Assays to Hot Water Leach, Wt. Avg. Assays (wt.%)

| Type | Mo | Ni | V | Fe | K | C* | S |
|---|---|---|---|---|---|---|---|
| Lo-V | 26.51 | 17.12 | 0.57 | 0.34 | 24.3 | 1.05 | <0.2 |

*: C from unreacted K₂CO₃

### Example 1D - Potassium Carbonate Calcine Hot Water Leaching

The K₂CO₃ calcine was leached in hot water at 75° C. (pH 10.5-11.0) at 15 wt.% solids for 1.5 hr without pH modification of the sample. The leach residue was vacuum filtered, washed and dried. The leach solution was set aside for near term hydrometallurgical separation of V from Mo.

Mo and V extractions up to 96% and 67% respectively (Table 6) were achieved from hot water leaching of the low-V potash calcine for overall Mo and V pyrometallurgical extractions of 99% and 96% respectively from the spent catalyst; a weight loss of up-to 72% was apparent (Table 9). Leach residue metal assays are represented in Table 7 and identifies Ni as constituting up-to ⅔^{rd} of the un-reacted solids phase.

TABLE 6

Hot Water Leach, Kinetic Period Extractions

| Time (min) | 45 | 90 | 45 | 90 |
|---|---|---|---|---|
| | Mo (%) | | V(%) | |
| Lo-Vanadium Potassium Carbonate Calcine | 88.0 | 95.8 | 65.5 | 67.1 |

TABLE 7

Hot Water Leach Residue from K₂CO₃ Calcine, Average Assays (wt.%)

| Type | Mo | Ni | V | Fe | Ca | K | Al | Co | Cr | Cu | Mg | Mn | Zn |
|---|---|---|---|---|---|---|---|---|---|---|---|---|---|
| Lo-V | 4.03 | 66.18 | 0.67 | 1.90 | 0.18 | 1.56 | 0.18 | 0.03 | <0.02 | 0.04 | 0.05 | 0.02 | 0.04 |

### Example 1E - Overall Mass Balance of Examples 1A Through 1D

Table 8 below indicates less than 5 wt.% of a high Ni residual persisted following the listed sequence of unit operations on the original low-V spent catalyst. This includes individual weight losses of up to 57% in the as-is calcine, up to 74.5% in the potash leach residue, a weight gain of up to 50% in the potash calcine a final weight loss of up to 72% in the final Ni residue and an overall weight loss from spent catalyst to Ni residue of up-to 95%

TABLE 8

Low-V Spent Catalyst Mass Loss in gm Sequence

| Spent Cat | Calcine | Leach Residue | Calcined Spinel* | Final Ni Residue |
|---|---|---|---|---|
| 100.00 | 43.00 | 10.97 | 16.45 | 4.61 |

note: *Includes approx. 25% of additional K₂CO₃ above stoichiometric

Table 9 illustrates the progression of metals removal or absence of metals depletion thereof from the spent catalyst feed to the insoluble Ni residue. Calculated values for Mo, V, Ni and Fe at the various stages may be compared with actual metal values in Tables 1, 2, 4, 5 and 7.

TABLE 9

Theoretical Metals Depletion per Unit Operation

| Wt. Loss or (Gain) | Lo-V Feed, Process Steps | Processed Wt. (g) | Mo (g) | Mo (wt.%) | V (g) | V (wt.%) | Ni (g) | Ni (wt.%) | Fe (g) | Fe (wt.%) |
|---|---|---|---|---|---|---|---|---|---|---|
| 0.00% | Spent Catalyst | 100.00 | 25.10 | 25.10 | 0.94 | 0.94 | 3.20 | 3.20 | 0.10 | 0.10 |
| 57.00% | Calcine | 43.00 | 25.10 | 58.37 | 0.94 | 2.19 | 3.20 | 7.44 | 0.10 | 0.23 |
| 74.50% | Leach Residue | 10.97 | 4.39 | 40.06 | 0.10 | 0.94 | 3.20 | 29.18 | 0.10 | 0.91 |
| (50.00)% | Calcined Spinel+K₂CO₃ | 16.45 | 4.39 | 26.71 | 0.10 | 0.63 | 3.20 | 19.46 | 0.10 | 0.61 |
| 72.00% | Ni Residue | 4.61 | 0.19 | 4.05 | 0.03 | 0.74 | 3.20 | 69.49 | 0.10 | 2.17 |
| Overall Pyrometallurgical Metal Extraction: | | | 99.30% | | 96.40% | | | | | |

### Example 1F Ammonium Metavanadate (AMV) Crystallization From Alkali Leach Pregnant Solution (FIG 1 Filtrates 45 and 95)

A stirred solution of the leach filtrate (pH 10.5 and above) was heated to 60° C. Sufficient 70% concentrated HNO₃ acid was added to lower the pH to approx. 8.8. 100-gpL NH₄NO₃ crystals was added and the pH adjusted to approx. 7.5 with HNO₃ or NH₄OH. If solution vanadium concentration was less than 10 gpL, an AMV seed/spike of 10 gpL was added in powder form to the hot stirred solution. The metathesis reaction was continued for 1.5 hour at 60° C. with pH maintained between 7.0 and 8.0.

The following double displacements constitute the metathesis or ion exchange between NH₄⁺ and K+depicted in reactions 1.9 and 1.10:

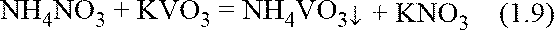

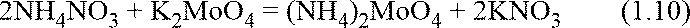

The solution was subsequently transferred to a vacuum cooling crystallizer at 10° C. under 21 in. Hg for 3 hrs with crystallization continued under gentle rotation. The AMV crystals were vacuum filtered with the filtrate set aside for Mo precipitation. The crystals were washed with three pore volumes of pure 4,800-mg/L AMV solution chilled to 10° C. The wash solution may be reused until the residual Mo concentration augments up-to 25,000 ppmw, after which it could be recycled to the metathesis circuit.

The yellowish AMV crystals were dried at 60° C.-70° C. Table 10 displays that continuous cooling crystallization at 10° C. is used to lower the V content in the barren solution. Estimated AMV purity includes up to 97 wt.% NH₄VO₃, with the remainder as Mo and K species together with NO₃⁻ anions. The barren solution or Mo filtrate was transferred to the acid precipitation circuit for Mo recovery.

TABLE 10

| Sample ID | Solution Chemistry | AMV Crystallization | | | | AMV Solids (wt.%) | | Barren Solution (wt.%) | | AMV Recovery (%) |
|---|---|---|---|---|---|---|---|---|---|---|
| | | Heating | Time (min) | Cooling | Time (min) | Mo | V | Mo | V | |
| A | Nitrate | 30° C. | 60 | 10° C. | 90 | 0.877 | 41.7 | 6.93 | 0.060 | 91 |
| B | Nitrate | Cooling at 10° C. only | | 10° C. | 180 | 0.388 | 42.0 | 6.89 | 0.033 | 95 |

### Example 1G Molybdenum Trioxide Precipitation From AMV Barren Solution (FIG. 2, Filtrate 125)

The stirred barren solution from the V crystallization circuit was heated to 65° C. followed by careful addition of 70% concentrated HNO₃ acid to pH approx. 1.0. The pH and temperature were maintained with adequate stirring for 2.5 hours. Table 11 depicts up to 99% Mo recovery within 2 hours at the lower pH and temperature and higher HNO₃ acid dosage. The slurry was cooled to near ambient at reaction termination and prior to filtration. The barren filtrate containing <1,000 mg/L Mo and <100 mg/L V may be transferred for Iron precipitation (in accordance with U.S. Pat. No. 9809870, issued Nov. 17, 2017; “Process for separating and recovering metals”, Bhaduri, Nordrum, Kuperman) and/or Ion-Exchange for residual metals removal.

Reaction 1.11 represents the MoO₃ precipitation sequence under acidic conditions:

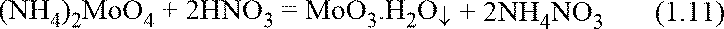

The MoO₃ cake solids were re-slurried at 25 wt.% solids in pH 1 Ammonium Heptamolybdate (AHM)* at ambient w/stirring for 15 min and vacuum filtered. The process was repeated at least two more times with fresh pH 1 AHM to ensure K⁺ content in the MoO₃ solids phase was <0.5 wt.%. The barren filtrate was recycled as re-pulp solution media. Solids were dried at 70° C. to 100° C.

Note: *pH 1 AHM was prepared by acidulating pure 200-gpL Ammonium Heptamolybdate (AHM) solution to pH 1 at 65° C. for 2.5 hrs with conc HNO₃ acid. Following liquid-solid separation, the MoO₃ solids may be recovered as final product and the filtrate used as wash solution for the commercial MoO₃ cake.

Estimated MoO₃ purity includes up to 95 wt.% MoO₃.H₂O, up to 0.75 wt.% total K and V and the remaining NH₄⁺ and NO₃⁻ ions.

The described sequence of wash steps was used to lower K⁺ ion levels to <0.5 wt.% in the MoO₃ product. The alkali metal acts as a poison during catalyst synthesis so reduced values are desired. K⁺ ion levels in the MoO₃ slurry may run up to 20% with an immobile and unremovable fraction of the K⁺ ion substituting hydronium ions in the layered MoO₃ structure.

TABLE 11

| Sample ID | Conditions | Time (min) | Wt.% Solids | Mo recovery (%) | V recovery (%) |
|---|---|---|---|---|---|
| A1 | 65° C., pH 1, conc | 60 | 12.2 | 92.8 | 62.9 |
| | HNO₃ added: | 120 | 12.4 | 99.0 | 79.7 |
| | 90-kg/mt solution | 240 | 13.3 | 99.1 | 84.3 |
| A2 | 75° C., pH^{~}1, conc | 60 | 12.5 | 91.3 | 44.2 |
| | HNO₃ added: | 120 | 14.2 | 98.6 | 83.1 |
| | 90-kg/mt solution | 180 | 13.3 | 99.1 | 86.0 |
| A3 | 75° C., pH^{~}1.6, conc | 60 | 16.6 | 93.8 | 20.7 |
| | HNO₃ added: | 120 | 17.7 | 98.8 | 25.5 |
| | 70-kg/mt solution | 240 | 19.7 | 99.1 | 28.8 |

The foregoing results demonstrate pyrometallurgical extractions of up to 99% Mo and up to 96% V coupled with hydrometallurgical recoveries of up to 99% Mo and up to 95% V. Overall metal recoveries are projected at 98% Mo and 90% V. The overall projections of V recoveries shown herein are conservative. It is expected that further processing may provide hydrometallurgical recoveries having higher V content. For example, the metals content in tails effluent off the molybdenum precipitation circuit may be scavenged by an Ion Exchange circuit to increase the metal recovery.

The following examples 2A through 2D provide results for as-is roasting of spent catalyst, followed by calcination with potassium carbonate and hot water leaching of the potassium carbonate calcine. The hydrometallurgical separation unit operations for V and Mo recovery are identical to Examples 1F and 1G.

### Example 2A - Roasting Spent Catalyst (as-is)

Controlled batch oxidation of 1,750 g de-oiled spent catalyst under O₂ starved conditions in a 7” diameter × 29” operating length rotary quartz tube furnace, simulating multiple hearth furnace conditions, with retention times of up to 8 hrs generated a calcine containing <0.1 wt.% S and C respectively.

The run began with a fast ramp-up to 500° C. under Argon gas flow to remove residual hydrocarbons in the spent catalyst. This was followed by a slow ramp to the operating bed temperature of 620° C. under reduced air flow, an extended hold period with CO₂ and SOₓ emission measurements, followed by a slow cool down under air flow during reaction termination. The staged temperature control was used to avoid significant heat release that would result in Mo loss and solids sintering. A weight loss of approx. 57% (Tables 17 and 18) was observed in a low-V calcine that corresponded to near complete S and C removal (<0.1 wt.%) and conversion of metal sulfides to metal oxides. Tables 12 and 13 provide metal assays on roaster feed and generated calcine.

TABLE 12

Roaster Feed Average Assays (wt.%)

| Type | Mo | Ni | V | Fe | C | H | S |
|---|---|---|---|---|---|---|---|
| Lo-V | 26.23 | 2.84 | 0.89 | 0.07 | 43.80 | 2.20 | 22.50 |

Table 13

Roaster Calcine Average Assays (wt.%)

| Type | Mo | Ni | V | Fe | C | S |
|---|---|---|---|---|---|---|
| Lo-V | 58.24 | 7.47 | 2.18 | 0.23 | 0.02 | 0.07 |

Reactions (2.1) through (2.6) below represent combustion reactions. Gibb’s free energies at 600° C. imply oxidation per the sequence V>Mo>Fe>Ni, while free energies at 600° C. for CO₂ and SO₂ imply that C will combust at a faster rate than S.

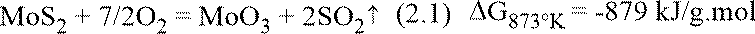

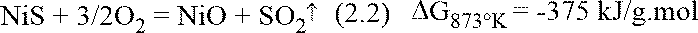

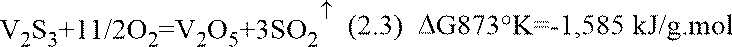

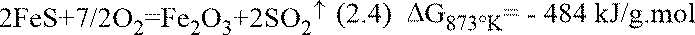

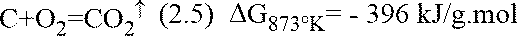

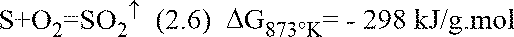

Due to the unsupported, high surface area characteristics of the deoiled material and the absence of alumina and/or silica, reaction 2.7 below depicts Nickel present in the feedstock securing onto Molybdenum during the combustion reactions at approx. 620° C. to form an un-leachable refractory NiMoO₄ spinel phase. This component was detected by both XRD & QEMSCAN (Quantitative Evaluation of Materials by Scanning Electron Microscopy).

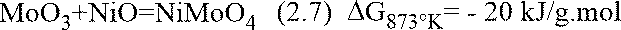

Another phase that could not be detected by XRD but was revealed by QEMSCAN included a mixed metal oxide of the form (MoₐNi_{b}V_{c})O_{d}. The V constituent in the mixed metal oxide was un-leachable in both caustic and acid environments.

### Example 2B - Roasted Product Calcination With Potassium Carbonate

Reactions (2.8) through (2.10) below represent K₂CO₃ reactions with the roaster product during calcination. Gibb’s free energies at 600° C. imply the favorability of the spinel phases breached with potash under these conditions:

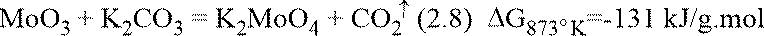

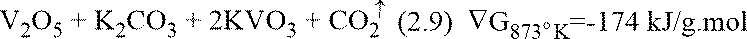

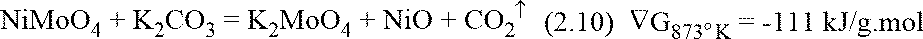

The roasted material (calcine) was blended with K₂CO₃ (Rocky Mountain Reagents, 28% passing 300 µm) at up-to 25% above the stoichiometric Mo and V content in the calcine. The run began in a 4” diameter × 14” operating length quartz kiln with a fast ramp-up to 500° C. under air flow followed by a slow ramp to the operating bed temperature of 620° C. under reduced air flow; a hold period of 2 hrs was sufficient to lower CO₂ emissions to <0.1 wt%. This was followed by a slow cool down to 100° C. under air flow prior to removing the kiln solids.

A weight gain of approx. 45% (Table 18) was observed in a low-V K₂CO₃ calcine that appeared to account for mostly near complete breaching of the spinel into water soluble molybdate and vanadate. No fusion, agglomerates or solids sintering was apparent with the calcine discharging effortlessly from the rotary kiln. Table 14 illustrates elemental composition of the solids following calcination of the caustic potash leach residue with K₂CO₃.

TABLE 14

Roasted Solids Calcined with K₂CO₃, Average Assays (wt.%)

| Type | Mo | Ni | V | Fe | K | C* | S |
|---|---|---|---|---|---|---|---|
| Lo-V | 29.00 | 3.47 | 1.20 | 0.10 | 33.40 | 1.41 | <0.20 |

Note: C* from unreacted K₂CO₃

### Example 2C - Potassium Carbonate Calcine Hot Water Leaching

The K₂CO₃ calcine was leached in hot water at 75° C. (pH 10.5-11.0) at 15 wt.% solids for 1.5 hr without pH modification of the sample. The leach residue was vacuum filtered, washed, dried and submitted for analyticals. The leach solution was set aside for near term hydrometallurgical separation of V from Mo.

Mo and V extractions up to 99% and 91% respectively (Table 15) were achieved from hot water leaching of the low-V K₂CO₃ calcine for overall Mo and V pyrometallurgical extractions of 99% and 91% respectively from the spent catalyst. A weight loss of up to 94% was apparent (Table 18). Leach residue metal assays are represented in Table 16 and identifies Ni as constituting up to ⅔^{rd} of the un-reacted solids phase.

TABLE 15

Hot Water Leach, Kinetic Period Extractions

| Time (min) | 45 | 90 | 45 | 90 |
|---|---|---|---|---|
| | Mo (%) | | V(%) | |
| Lo-Vanadium Potassium Carbonate Calcine | 96.2 | 99.3 | 87.3 | 91.2 |

TABLE 16

Hot Water Leach Residue from K₂CO₃ Calcine, Average Assays (wt.%)

| Type | Mo | Ni | V | Fe | Ca | K | Al | Co | Cr | Cu | Mg | Mn | Zn |
|---|---|---|---|---|---|---|---|---|---|---|---|---|---|
| Lo-V | 3.57 | 64.60 | 1.82 | 1.60 | 0.18 | 1.53 | 0.18 | 0.03 | <0.02 | 0.04 | 0.06 | 0.02 | 0.05 |

### Example 2D - Overall Mass Balance of Examples 2A Through 2C

Table 17 below indicates less than 4 wt.% of a high Ni residual persisted following the listed sequence of unit operations on the original low V spent catalyst. This includes individual weight losses of up to 57% in the as-is calcine, a weight gain of up to 45% in the potash calcine a final weight loss of up to 94% in the final Ni residue. and an overall weight loss from spent catalyst to Ni residue of up-to 96%.

TABLE 17

Low-V Spent Catalyst Mass Loss in gm Sequence

| Spent Cat | Calcine | K₂CO₃ Calcine* | Final Ni Residue |
|---|---|---|---|
| 100.00 | 43.00 | 62.35 | 3.74 |

Note: *Includes approx. 25% of additional K₂CO₃ above stoichiometric

Table 18 illustrates the theoretical progression of metals removal or absence of metals depletion thereof from the spent catalyst feed to the insoluble Ni residue. Calculated values for Mo, V, Ni and Fe at the various stages may be compared with actual metal values in Tables 12, 13, 14 and 16. The hydrometallurgical separation unit operations for V and Mo are identical to Examples 1F and 1G.

TABLE 18

Theoretical Metals Depletion per Unit Operation

| Wt. Loss or (Gain) | Lo-V Feed, Process Steps | Processed Wt. (g) | Mo (g) | Mo (wt.%) | Mo Extm (%) | V (g) | V (wt.%) | V Extm (%) | Ni (g) | Ni (wt.%) | Fe (g) | Fe (wt.%) |
|---|---|---|---|---|---|---|---|---|---|---|---|---|
| 0.00% | Spent Catalyst | 100.00 | 26.23 | 26.23 | 0.00 | 0.89 | 0.89 | 0.00 | 2.84 | 2.84 | 0.07 | 0.07 |
| 57.00% | Calcine Spinel+K₂C | 43.00 | 26.23 | 61.00 | 0.00 | 0.89 | 2.08 | 0.00 | 2.84 | 6.60 | 0.07 | 0.15 |
| (45.00) % | O₃ Calcination | 62.35 | 26.23 | 42.07 | 0.00 | 0.89 | 1.43 | 0.00 | 2.84 | 4.55 | 0.07 | 0.11 |
| 94.00% | Ni Residue | 3.74 | 0.18 | 4.91 | 99.30 | 0.08 | 2.10 | 91.20 | 2.84 | 75.92 | 0.07 | 1.76 |
| Overall Pyrometallurgical Metal Extraction: | | | | | 99.3% | | | 91.2% | | | | |

The foregoing results demonstrate pyrometallurgical extractions of up to 99% Mo and up to 91% V coupled with hydrometallurgical recoveries of up to 99% Mo and up to 95% V. The overall metal recoveries are projected at 98% Mo and 87% V. The overall projections of V recoveries shown herein are conservative. It is expected that further processing of the Mo barren solution may provide hydrometallurgical recoveries with higher V content. For example, the metals content in tails effluent off the molybdenum precipitation circuit may be scavenged by an Ion Exchange circuit to increase the metal recovery.

As shown, the approach demonstrated by examples 2A-D (following Example 1, using Roasting (as-is) – Calcination w/K₂CO₃ – Hot Water Leaching of K₂CO₃ Calcine) culminated in the elimination of an entire unit operation namely KOH leaching of the roasted material or calcine.

The following examples 3A to 3C provide results for roasting of spent catalyst with potassium carbonate, followed by hot water leaching of the potassium carbonate calcine. The hydrometallurgical separation unit operations for V and Mo recovery are identical to Examples 1F and 1G.

### Example 3A - Roasting Spent Catalyst With Potassium Carbonate

Reactions (3.1) through (3.7) below represent the pertinent metal oxidation reactions with K₂CO₃. Gibb’s free energies at 600° C. imply favorable oxidation per the sequence V>Mo>Fe>Ni>C>S. Free energies at 600° C. for CO₂ and SO₂ imply that C will combust at a faster rate than S.

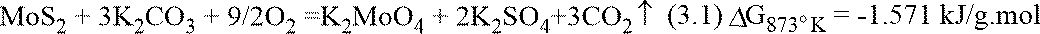

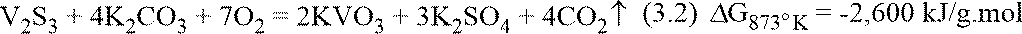

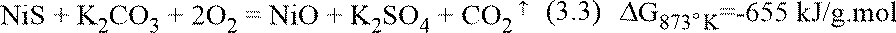

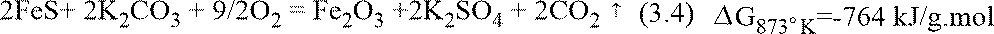

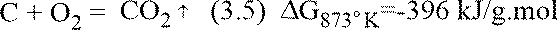

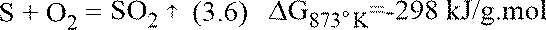

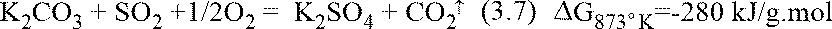

Controlled batch oxidation of 100 g of spent catalyst blended with K₂CO₃ (Rocky Mountain Reagents, 28% passing 300 µm) under O₂ starved conditions in a 4” diameter × 14” operating length rotary quartz tube furnace, simulating multiple hearth furnace conditions, with retention times of up to 4 hrs generated a calcine containing approx. 0.1 wt.% S and <0.5 wt.% C respectively. The spent catalyst was thoroughly blended with anhydrous K₂CO₃ at 25% above the stoichiometric Mo and V content in the calcine.

The run began with a fast ramp-up to 500° C. under Argon gas flow at 3 slpm (standard liter per minute) to remove residual hydrocarbons in the spent catalyst followed by a slow ramp to the operating bed temperature of 580° C. under reduced air flow of 3 slpm, an extended hold period with CO₂ and SOₓ emission measurements with increased air flow of up to 5 slpm. During the last hour of the roast, temperature was increased to 620° C. followed by a slow cool down under air flow during reaction termination. The lower initial combustion temperatures were used to avoid some eutectics fusing, forming large agglomerates and adhering to the kiln. The higher temperature in the last hour ensured complete S and C combustion and higher V extraction. Minimal SOₓ evolution was evident indicating conversion of the sulfides directly to sulfate.

A weight gain of approx. 92% (Tables 23 and 24) was observed in a low-V K₂CO₃ calcine that apparently revealed some fusion and agglomeration. The calcine, however, discharged effortlessly from the rotary kiln. The fusion is speculated to occur with the formation of low melting point potassium molybdates and vanadates (approx. 500° C.) that may contribute to calcine agglomeration in tandem with the tumbling action of the rotary kiln. This in itself is not a deficiency as it should reduce dusting and fines losses in the roaster. Tables 19 and 20 below illustrate metal assays on roaster feed and the potash calcine.

TABLE 19

Roaster Feed Average Assays (wt.%)

| Type | Mo | Ni | V | Fe | C | H | S |
|---|---|---|---|---|---|---|---|
| Lo-V | 24.40 | 2.85 | 1.13 | 0.07 | 43.35 | 2.14 | 20.10 |

Table 20

Roaster K₂CO₃ Calcine Average Assays (wt.%)

| Type | Mo | Ni | V | Fe | C* | S* |
|---|---|---|---|---|---|---|
| Lo-V | 12.41 | 1.29 | 0.65 | 0.03 | 2.52 | 9.21 |

Note: C* from unreacted K₂CO₃ and S* from generated K₂SO₄

### Example 3B - Potassium Carbonate Calcine Hot Water Leaching

The K₂CO₃ calcine was leached in hot water at 75° C. (pH 10.5-11.0) at 15 wt.% solids for 2 hr without pH modification of the sample. The leach residue was vacuum filtered, washed, dried and submitted for analyticals. The leach solution was set aside for near term hydrometallurgical separation of V from Mo. Mo and V extractions up to 99% and 93% respectively (Table 21) were achieved from hot water leaching of the low-V K₂CO₃ calcine for overall Mo and V pyrometallurgical extractions of 99% and 93% respectively from the spent catalyst. A weight loss of up to 96% was apparent (Table 24).

Leach residue metal assays are represented in Table 22 and identifies Ni as constituting up to ⅓^{rd} of the un-reacted solids phase. The decrease in Ni content, as compared to Examples 1D and 2C, is indicative of formation of a different Ni moiety, Nickel hydroxy carbonate [Ni(OH)₂.(HCO₃)₂], that accounts for approx. 27% stoichiometric Ni content.

TABLE 21

Hot Water Leach, Kinetic Period Extractions

| Time (min) | 60 | 120 | 60 | 120 |
|---|---|---|---|---|
| | Mo (%) | | V(%) | |
| Lo-Vanadium Potassium Carbonate Calcine | 94.4 | 98.7 | 86.4 | 93.0 |

TABLE 22

Hot Water Leach Residue from K₂CO₃ Calcine, Average Assays (wt.%)

| Type | Mo | Ni | V | Fe | Ca | K | Al | Co | Cr | Cu | Mg | Mn | Zn |
|---|---|---|---|---|---|---|---|---|---|---|---|---|---|
| Lo-V | 4.12 | 29.51 | 1.13 | 1.06 | 0.05 | 4.6 | 0.19 | 0.02 | 0.08 | 0.025 | 0.03 | 0.016 | 0.09 |

### Example 3C - Overall Mass Balance of Examples 3A and 3B

Table 23 indicates less than 8 wt.% of a high Ni residual persisted following the listed sequence of unit operations on the original low V spent catalyst. This includes a weight gain of up to 92% in the potash calcine a weight loss of up to 96% in the final Ni residue and an overall weight loss from spent catalyst to Ni residue of up-to 92%.

TABLE 23

Low-V Spent Catalyst Mass Loss in gm Sequence

| Spent Cat | K₂CO₃ Calcine* | Final Ni Residue |
|---|---|---|
| 100.00 | 191.80 | 7.46 |

Note: *Includes approx. 25% of additional K₂CO₃ above stoichiometric Mo and V content

Table 24 illustrates the theoretical progression of metals removal or absence of metals depletion thereof from the spent catalyst feed to the insoluble Ni residue. Calculated values for Mo, V, Ni and Fe at the various stages may be compared with actual metal values in Tables 19, 20 and 22. The hydrometallurgical separation unit operations for V and Mo are identical to Examples 1F and 1G.

TABLE 24

Theoretical Metals Depletion per Unit Operation

| Wt. Loss or (Gain) | Lo-V Feed, Process Steps | Processed Wt. (g) | Mo (g) | Mo (wt.%) | Mo Extm (%) | V (g) | V (wt.%) | V Extm (%) | Ni (g) | Ni (wt.%) | Fe (g) | Fe (wt.%) |
|---|---|---|---|---|---|---|---|---|---|---|---|---|
| 0.00% | Spent Catalyst | 100.00 | 24.40 | 24.40 | 0.00 | 1.13 | 1.13 | 0.00 | 2.85 | 2.85 | 0.07 | 0.07 |
| (91.80)% | K₂CO₃ Calcine | 191.80 | 24.40 | 12.72 | 0.00 | 1.13 | 0.59 | 0.00 | 2.85 | 1.49 | 0.07 | 0.04 |
| 96.11% | Ni Residue | 7.46 | 0.32 | 4.25 | 98.70 | 0.08 | 1.06 | 93.00 | 2.85 | 38.20 | 0.07 | 0.94 |
| Overall Pyrometallurgical Metal Extraction: | | | | | 98.7% | | | 93.0% | | | | |

The foregoing results demonstrate pyrometallurgical extractions of up to 99% Mo and up to 93% V coupled with hydrometallurgical recoveries of up to 99% Mo and up to 95% V. Overall metal recoveries are projected at 98% Mo and 88% V. The overall projections of V recoveries are conservative. It is expected that further processing may provide hydrometallurgical recoveries having higher V content. For example, the metals content in tails effluent off the molybdenum precipitation circuit may be scavenged by an Ion Exchange circuit to increase the metal recovery.

A shown, the approach demonstrated by examples 3A-C (following Example 1, using Roasting w/K₂CO₃ – Hot Water Leaching of K₂CO₃ Calcine) culminated in the elimination of two entire unit operations, namely KOH leaching of the roasted material or calcine and KOH Leach Residue Calcination w/K₂CO₃.

Additional details concerning the scope of the invention and disclosure may be determined from the appended claims.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A method for recovering metals from a deoiled spent catalyst, wherein the catalyst comprises a Group VIB metal, a Group VIIIB metal, and a Group VB metal, the method comprising:
heating a deoiled spent catalyst comprising a Group VIB metal, a Group VIIIB metal, and a Group VB metal under oxidative conditions at a first pre-selected temperature for a first time sufficient to reduce the levels of sulfur and carbon to less than pre-selected amounts and to form a calcined spent catalyst;
contacting the calcined spent catalyst with a leach solution comprising potassium hydroxide leach solution to form a spent catalyst slurry at a pre-selected leach temperature for a pre-selected leach time and at a pre-selected leach pH;
separating and removing a first filtrate and a first solid residue from the spent catalyst slurry, the first filtrate comprising a soluble Group VIB metal compound and a soluble Group VB metal compound and the first solid residue comprising an insoluble Group VIIIB/Group VIB/Group VB metal compound;
drying the insoluble Group VIIIB/Group VIB/Group VB metal compound first solid residue;
combining the dried Group VIIIB/Group VIB/Group VB metal compound first solid residue with potassium carbonate to form a solid residue/potassium carbonate mixture;
heating the metal compound solid residue/potassium carbonate mixture at a second pre-selected temperature and for a second pre-selected time under gas flow conditions to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a second filtrate and a second solid residue from the potassium carbonate calcine slurry, the second filtrate comprising the soluble Group VIB metal compound and the soluble Group VB metal compound and the second solid residue comprising an insoluble Group VIIIB metal compound; and
recovering the soluble Group VIB metal compound and the soluble Group VB metal compound from the spent catalyst slurry first filtrate and from the potassium carbonate calcine slurry second filtrate.

2. A method for recovering metals from a deoiled spent catalyst, wherein the catalyst comprises a Group VIB metal, a Group VIIIB metal, and a Group VB metal, the method comprising:
heating a deoiled spent catalyst comprising a Group VIB metal, a Group VIIIB metal, and a Group VB metal under oxidative conditions at a first pre-selected temperature for a first time sufficient to reduce the levels of sulfur and carbon to less than pre-selected amounts and to form a calcined spent catalyst;
combining the calcined spent catalyst comprising Group VIII, Group VIB, and Group VB metal compounds with potassium carbonate to form a calcined spent catalyst/potassium carbonate mixture;
heating the calcined spent catalyst/potassium carbonate mixture at a second pre-selected temperature and for a second pre-selected time under gas flow conditions to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a filtrate and a solid residue from the potassium carbonate calcine slurry, the filtrate comprising the soluble Group VIB metal compound and the soluble Group VB metal compound and the solid residue comprising an insoluble Group VIIIB metal compound; and
recovering the soluble Group VIB metal compound and the soluble Group VB metal compound from the potassium carbonate calcine slurry filtrate.

3. A method for recovering metals from a deoiled spent catalyst, wherein the catalyst comprises a Group VIB metal, a Group VIIIB metal, and a Group VB metal, the method comprising:
combining the spent catalyst comprising Group VIII, Group VIB, and Group VB metal compounds with potassium carbonate to form a spent catalyst/potassium carbonate mixture;
heating the spent catalyst/potassium carbonate mixture under oxidative conditions at a pre-selected temperature for a time sufficient to reduce the levels of sulfur and carbon to less than pre-selected amounts and to form a potassium carbonate calcine;
contacting the potassium carbonate calcine with water to form a potassium carbonate calcine slurry at a temperature and for a time sufficient to leach a soluble Group VIB metal compound and a soluble Group VB metal compound from the potassium carbonate calcine;
separating and removing a filtrate and a solid residue from the potassium carbonate calcine slurry, the filtrate comprising the soluble Group VIB metal compound and the soluble Group VB metal compound and the solid residue comprising an insoluble Group VIIIB metal compound; and
recovering the soluble Group VIB metal compound and the soluble Group VB metal compound from the potassium carbonate calcine slurry filtrate.

4. The method of claim 1, wherein the deoiled spent catalyst is substantially devoid of residual hydrocarbons, or is devoid of residual hydrocarbons, or comprises residual hydrocarbons in an amount of less than about 1000 ppm.

5. The method of claim 1, wherein the deoiled spent catalyst comprises residual hydrocarbons and the process further comprises heating the catalyst under optionally non-oxidative conditions at a pre-selected temperature for a time sufficient to reduce the level of residual hydrocarbons to an amount of less than about 1000 ppm.

6. The method of claim 1, wherein the oxidative first pre-selected temperature is in the range of about 575° C. to 600° C., or 600-625° C., or 625-650° C.

7. The method of claim 3, wherein the oxidative pre-selected temperature is in the range of about 575° C. to 600° C., or 600-625° C., or 625-650° C.

8. The method of claim 1, wherein the deoiled spent catalyst is substantially devoid of catalyst support materials comprising alumina, silica, titania, or a combination thereof, or wherein a catalyst support material comprising alumina, silica, titania, or a combination thereof is not used to prepare the catalyst.

9. The method of claim 1, wherein the spent catalyst comprises or is a slurry catalyst.

10. The method of claim 1, wherein the oxidative heating conditions comprise heating in the presence of an inert gas, air, or a combination thereof.

11. The method of claim 1, wherein the oxidative heating conditions comprise heating the deoiled spent catalyst at the first pre-selected temperature in the presence of air, or a gas mixture comprising no more than about 20 vol.% oxygen.

12. The method of claim 1, wherein the first pre-selected temperature is greater than about 600° C.

13. The method of claim 1, wherein the levels of sulfur and carbon are individually or both reduced to less than pre-selected amounts, as measured by CO₂ and SO₂ off-gas analysis, of less than about 1 wt.%.

14. The method of claim 1, wherein the pre-selected leach temperature is greater than about 60° C.

15. The method of claim 1, wherein the pre-selected leach time is in the range of about 1 to 5 hr.

16. The method of claim 1, wherein the pre-selected leach pH is in the range of about 9.5 to 11.

17. The method of claim 1, wherein the first filtrate comprises soluble molybdate or vanadate compounds, or a mixture thereof.

18. The method of claim 1, wherein the first filtrate contains greater than about 80 wt.% of the Group VIB metal or greater than about 85 wt.% of the Group VB metal present in the deoiled spent catalyst, or both greater than about 80 wt.% of the Group VIB metal and greater than about 85 wt.% of the Group VB metal present in the deoiled spent catalyst.

19. The method of claim 1, wherein the first solid residue is dried at a temperature in the range of about 110-140° C. for a time period in the range of 0.5 to 2 hr.

20. The method of claim 1, wherein the first solid residue is dried at a temperature and for a time sufficient to reduce the amount of water to less than about 2 wt.%.

21. The method of claim 1, wherein the first solid residue comprises Group VB metal and/or Group VIB metal and/or Group VIIIB metal compound solids.

22. The method of claim 1, wherein the second pre-selected temperature is greater than about 600° C.

23. The method of claim 1, wherein the second pre-selected time is in the range of about 0.5 to 2 hr.

24. The method of claim 1, wherein the gas flow conditions during the potassium carbonate calcination comprise an inert gas or air and are sufficient to remove any off-gases.

25. The method of claim 1, wherein the potassium carbonate calcine is contacted with water to form the potassium carbonate calcine slurry at a temperature greater than about 60° C.

26. The method of claim 1, wherein the potassium carbonate calcine leach time is in the range of 0.5 to 4 hr.

27. The method of claim 1, wherein the potassium carbonate calcine leach is conducted without pH modification.

28. The method of claim 1, wherein the second filtrate comprises potassium molybdate, potassium vanadate, or a mixture thereof.

29. The method of claim 21, wherein the second filtrate contains the Group VB metal present in the Group VB and/or Group VIB metal compound in an amount greater than about 60 wt.%.

30. The method of claim 21, wherein the second filtrate contains the Group VIB metal present in the Group VB and/or Group VIB metal compound in an amount greater than about 90 wt.%.

31. The method of claim 1, wherein the overall extraction of the Group VB metal present in the deoiled spent catalyst is greater than about 85 wt.%.

32. The method of claim 1, wherein the overall extraction of the Group VIB metal present in the deoiled spent catalyst is greater than about 90 wt.%.

33. A method for separately recovering Group VIB and Group VB metal compounds, wherein the Group VIB and Group VB metal compounds are provided as an aqueous mixture comprising Group VIB and Group VB metal compounds according to the method of claim 1, the method comprising:
contacting the Group VIB and Group VB metal compound aqueous mixture with an ammonium salt under metathesis reaction conditions effective to convert the metal compounds to ammonium Group VB metal and ammonium Group VIB metal compounds;
subjecting the mixture comprising the ammonium Group VB metal compound to conditions effective to crystallize the ammonium Group VB metal compound;
filtering and washing the crystallized ammonium Group VB metal compound with a saturated ammonium Group VB metal compound wash solution at a pre-selected wash temperature and separately recovering the ammonium Group VB metal compound and an ammonium Group VIB metal compound filtrate;
heating the ammonium Group VB metal compound under conditions effective to release ammonia and separately recovering the Group VB metal compound and ammonia;
contacting the ammonium Group VIB metal compound filtrate with an inorganic acid under conditions effective to form a Group VIB metal oxide compound precipitate and an ammonium salt of the inorganic acid;
filtering and washing the Group VIB metal oxide compound precipitate with a ammonium Group VIB metal oxide compound wash solution at a pre-selected wash temperature and recovering the Group VIB metal oxide compound precipitate.

34. The method of claim 33, wherein Group VB metal comprises vanadium and/or the Group VIB metal comprises molybdenum.

35. The method of claim 33, wherein the aqueous mixture comprising Group VIB and Group VB metal compounds comprises a potassium salt of the Group VIB compound and a potassium salt of the Group VB metal compound.

36. The method of claim 33, wherein the ammonium salt comprises ammonium nitrate.

37. The method of claim 33, wherein the metathesis reaction conditions comprise a pH in the range of less than about 9; a temperature in the range of less than about 80° C.; and/or a reaction time in the range of about 0.25 to 2 hr.

38. The method of claim 33, wherein the metathesis reaction conditions comprise the conversion of potassium vanadate to the corresponding ammonium vanadate compound and potassium salt.

39. The method of claim 33, wherein the metathesis reaction conditions comprise the sequential steps of adjusting the pH of the aqueous mixture to a range of about 8 to about 9, adding the ammonium salt to the aqueous mixture, and adding ammonium Group VB metal compound seed at a pH in the range of about 7.5 to 8.5 to the aqueous mixture.

40. The method of claim 33, wherein the Group VIB/Group VB metal compound mixture is an aqueous filtrate mixture, or an aqueous filtrate mixture from a spent catalyst metals recovery process.

41. The method of claim 33, wherein the ammonium Group VB metal compound crystallization conditions comprise a temperature in the range of greater than 0° C. to about 15° C., vacuum conditions, and a crystallization time period of about 1 hr to about 6 hr.

42. The method of claim 33, wherein the filtering and washing of the crystallized ammonium Group VB metal compound conditions comprise a wash temperature in the range of greater than 0° C. to about 15° C., optionally, wherein the crystallized ammonium Group VB metal compound and the wash solution comprise ammonium metavanadate and, optionally, wherein the wash solution is recycled for crystallization of the ammonium Group VB metal compound.

43. The method of claim 33, wherein the conditions for heating of the ammonium Group VB metal compound comprise heating the ammonium Group VB metal compound at a temperature in the range of about 200-450° C. for a time sufficient to release ammonia in an amount of at least about 90% of the amount present in the ammonium Group VB metal compound.

44. The method of claim 33, wherein the conditions for contacting of the ammonium Group VIB metal compound filtrate with an inorganic acid comprise introducing the inorganic acid at a temperature in the range of about 50 to 80° C. to provide a pH of about 1-3, optionally, wherein the inorganic acid comprises nitric acid or sulfuric acid, or is nitric acid.

45. The method of claim 33, wherein the conditions for filtering and washing of the Group VIB metal oxide compound precipitate with an ammonium Group VIB metal oxide compound wash solution comprise a wash temperature in the range of greater than 0° C. to about 15° C., optionally, wherein the wash solution comprises ammonium heptamolybdate depleted of Mo at pH 1 and, optionally, wherein the wash solution is recycled for filtering and washing of the Group VIB metal oxide compound.

46. The method of claim 1, wherein the overall recovery of the Group VB metal present in the solution comprising the Group VIB and Group VB metal compounds is greater than about 85 wt.%.

47. The method of claim 1, wherein the overall recovery of the Group VIB metal present in the solution comprising the Group VIB and Group VB metal compounds is greater than about 85%.

48. The method of claim 1, wherein the solution comprising the Group VIB and Group VB metal compounds is derived from a deoiled spent catalyst, or is a filtrate comprising Group VIB and Group VB metal compounds.

49. The method of claim 33, wherein the saturated ammonium Group VB metal compound wash solution comprises the same ammonium Group VB metal compound as the crystallized ammonium Group VB metal compound, or wherein the saturated ammonium Group VB metal compound of the wash solution is the same ammonium Group VB metal compound as the crystallized ammonium Group VB metal compound.

50. The method of claim 33, wherein the ammonium Group VIB metal oxide compound wash solution comprises the same ammonium Group VIB metal oxide compound as the crystallized ammonium Group VIB metal oxide compound, or wherein the ammonium Group VIB metal oxide compound of the wash solution is the same ammonium Group VIB metal oxide compound as the crystallized ammonium Group VB metal compound.

51. (canceled)

52. A combined pyrometallurgical and hydrometallurgical method for recovering metals from a deoiled spent catalyst, the combined method comprising the method of claim 1, and further comprising:
contacting a Group VIB and Group VB metal compound aqueous mixture with an ammonium salt under metathesis reaction conditions effective to convert the metal compounds to ammonium Group VB metal and ammonium Group VIB metal compounds, wherein the Group VIB and Group VB metal compound aqueous mixture is provided according to the method of claim 1;
subjecting the mixture comprising the ammonium Group VB metal compound to conditions effective to crystallize the ammonium Group VB metal compound;
filtering and washing the crystallized ammonium Group VB metal compound with a saturated ammonium Group VB metal compound wash solution at a pre-selected wash temperature and separately recovering the ammonium Group VB metal compound and an ammonium Group VIB metal compound filtrate;
heating the ammonium Group VB metal compound under conditions effective to release ammonia and separately recovering the Group VB metal compound and ammonia;
contacting the ammonium Group VIB metal compound filtrate with an inorganic acid under conditions effective to form a Group VIB metal oxide compound precipitate and an ammonium salt of the inorganic acid;
filtering and washing the Group VIB metal oxide compound precipitate with a ammonium Group VIB metal oxide compound wash solution at a pre-selected wash temperature and recovering the Group VIB metal oxide compound precipitate.

53. (canceled)
